(19) United States
(12) Patent Application Publication
(10) Pub. No.: US 2026/0121945 A1
(43) Pub. Date: Apr. 30, 2026

(54) NETWORK MANAGEMENT AND CONTROL ARCHITECTURE FOR EXTENDED END-TO-END (E2E) DYNAMIC NETWORK/RESOURCE SLICING AND SELECTION

(71) Applicant: AT&T Intellectual Property I, L.P., Atlanta, GA (US)

(72) Inventors: Zhi Cui, Sugar Hill, GA (US); Ye Chen, Marietta, GA (US); Hongyan Lei, Plano, TX (US)

(73) Assignee: AT&T Intellectual Property I, L.P., Atlanta, GA (US)

(21) Appl. No.: 18/927,072

(22) Filed: Oct. 25, 2024

(51) Int. Cl. H04L 41/5009; H04W 84/12

(52) U.S. Cl. CPC H04L 41/5009; H04W 84/12

(57) ABSTRACT

Aspects of the subject disclosure may include, for example, receiving a service request relating to a user device, identifying service delivery requirements for the service request, resulting in identified requirements, obtaining first information from a first intelligent controller regarding resources in network(s) that are associated with a premises, wherein the premises comprises a residential/commercial premises, obtaining second information from a second intelligent controller regarding resources in the user device, based on the identified requirements and the first and second information, selecting a first resource in the network(s) and a second resource in the user device, and facilitating service delivery for the user device by coordinating with the first intelligent controller to utilize the first resource for delivery of traffic associated with the service request and by coordinating with the second intelligent controller to utilize the second resource for processing relating to the traffic. Other embodiments are disclosed.

### FIELD OF THE DISCLOSURE

The subject disclosure relates to end-to-end (E2E) dynamic network/resource slicing and selection that is extended to home/business (or local) networks and end user devices.

### BACKGROUND

Network slicing, as defined in 3^{rd} Generation Partnership Project (3GPP), is a logical network that provides specific capabilities and characteristics via resources of one or more networks, particularly a radio access network (RAN). As the number of Internet-of-Things (IoT) devices in homes and businesses continues to increase, and with the advent of new technologies such as Wi-Fi 7, intelligent home/business networking and seamless connectivity to the outside world will become increasingly important.

Presently, end user devices typically automatically switch to Wi-Fi when available and use cellular data otherwise. With the deployment of 5G millimeter wave (mmWave) technology, network speed has become a critical factor in network selection, with mmWave cells being favored over Wi-Fi in good coverage areas. With the ever increasing number IoT devices, Wi-Fi may not always be the optimal choice for connectivity.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within, or operatively overlaid upon, the communications network of FIG. 1 in accordance with various aspects described herein.

FIG. 2B depicts an illustrative embodiment of a method in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 3 is a block diagram illustrating an example, non-limiting embodiment of a virtualized communications network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments of an E2E service-based network management and control architecture that encompasses home/business networks and end user device resources. The exemplary architecture may include a home/business network intelligent controller (HIC) that is configured with a microservice-based framework for managing the use of home/business network resources. The exemplary architecture may also include a device intelligent controller (DIC) that is configured with a microservice-based framework for managing the use of end user device resources.

In various embodiments, the architecture may be equipped with network/resource slicing functionality across network domains that include access

networks, transport network, core networks, home/business networks, and end user device resources. A service management and orchestration (SMO) system may include a slice orchestrator (SO) system that is configured to communicate with the various network/device segment controllers, including the HIC and the DIC, regarding slicing requirements, policies, etc. The HIC may include a network slicing microservice for managing slices of resources in the home/business network(s). Similarly, the DIC may include a resource slicing microservice for managing slices of resources in an end user device.

The SMO system may additionally, or alternatively, include intelligent network selection and mobility microservices that are configured to communicate with respective counterpart microservices in the HIC and the DIC to facilitate dynamic network selection and mobility handovers based on policies that factor in application type, device type, mobility state, etc.

Exemplary embodiments described herein advantageously extend E2E network slicing and management to home/business networks and end user devices, which allows for dynamic allocation of network/device resources that is tailored to the specific requirements of various applications or service requests. By incorporating intelligent (e.g., real-time) network selection and mobility management, the exemplary architecture provides for effective connectivity based on factors, including, but not limited to, signal strength, network speed, congestion, security concerns, and/or access restrictions. This results in improved network performance and seamless user experiences, as the system can facilitate dynamic switching between cellular and Wi-Fi networks to maintain a reliable connection.

One or more aspects of the subject disclosure include a device, comprising a processing system including a processor, and a memory that stores executable instructions that, when executed by the processing system, facilitate performance of operations. The operations can include receiving a service request relating to a user device. Further, the operations can include identifying service delivery requirements for the service request, resulting in identified requirements. Further, the operations can include obtaining first information from a first intelligent controller regarding resources in one or more networks that are associated with a premises, wherein the premises comprises a residential premises

or a commercial premises. Further, the operations can include obtaining second information from a second intelligent controller regarding resources in the user device. Further, the operations can include based on the identified requirements, the first information, and the second information, selecting a first resource in the one or more networks and a second resource in the user device. Further, the operations can include facilitating service delivery for the user device by coordinating with the first intelligent controller to utilize the first resource for delivery of traffic associated with the service request and by coordinating with the second intelligent controller to utilize the second resource for processing relating to the traffic.

One or more aspects of the subject disclosure include a non-transitory machine-readable medium, comprising executable instructions that, when executed by a processing system including a processor, facilitate performance of operations. The operations can include providing, to an SMO system, information regarding resources in one or more networks, wherein the one or more networks are associated with a premises, wherein the premises comprises a residential premises or a commercial premises, and wherein the providing is responsive to the SMO system receiving a service request relating to a user device. Further, the operations can include based on the providing, receiving, from the SMO system, an instruction to utilize a first resource in the one or more networks for delivery of traffic associated with the service request. Further, the operations can include responsive to the receiving, causing the first resource in the one or more networks to be utilized for delivering the traffic.

One or more aspects of the subject disclosure include a method. The method can comprise providing, by a processing system of a user device including a processor, and to an SMO system, information regarding resources in the user device, wherein the providing is responsive to the SMO system receiving a service request relating to the user device. Further, the method can include based on the providing, receiving, by the processing system and from the SMO system, an instruction to utilize a first resource in the user device for processing relating to traffic that is associated with the service request. Further, the method can include responsive to the receiving, causing, by the processing system, the first resource in the user device to be utilized for the processing relating to the traffic.

One or more aspects of the subject disclosure include a device, comprising a processing system including a processor, and a memory that stores executable instructions that, when executed by the processing system, facilitate performance of operations. The operations can include receiving a service request relating to a user device. Further, the operations can include identifying service delivery requirements for the service request, resulting in identified requirements. Further, the operations can include obtaining a resource slice based on the service delivery requirements. Further, the operations can include providing data regarding the resource slice to a first intelligent controller and a second intelligent controller, wherein the first intelligent controller relates to one or more networks that are associated with a premises, wherein the premises comprises a residential premises or a commercial premises, wherein the second intelligent controller relates to the user device, and wherein the providing causes the first intelligent controller to manage use of resources in the one or more networks to facilitate traffic delivery for the service request and causes the second intelligent controller to manage use of resources in the user device to facilitate data processing for the service request.

One or more aspects of the subject disclosure include a non-transitory machine-readable medium, comprising executable instructions that, when executed by a processing system including a processor, facilitate performance of operations. The operations can include receiving, from an SMO system, data regarding a resource slice, wherein the resource slice is created by the SMO system based on service delivery requirements relating to a service request for a user device. Further, the operations can include based on the receiving, facilitating traffic delivery for the service request by managing use of resources in one or more networks that are associated with a premises, wherein the premises comprises a residential premises.

One or more aspects of the subject disclosure include a method. The method can comprise receiving, by a processing system of a user device including a processor, and from an SMO system, data regarding a resource slice, wherein the resource slice is created by the SMO system based on service delivery requirements relating to a service request for a user device. Further, the method can include obtaining, by the processing system, a user policy regarding use of resources in the user device. Further, the method can include facilitating, by the processing system, data processing for the service request by managing use of the resources in the user device based on the data and the user policy.

One or more aspects of the subject disclosure include a device, comprising a processing system including a processor, and a memory that stores executable instructions that, when executed by the processing system, facilitate performance of operations. The operations can include obtaining data regarding one or more local networks, wherein the one or more local networks provide network connectivity for a user device. Further, the operations can include receiving policy information from an SMO system. Further, the operations can include causing the data and the policy information to be provided to an access intelligent controller (AIC) that is associated with one or more access networks, wherein the causing enables the AIC to determine whether to effect a handover for the user device from the one or more local networks to the one or more access networks.

One or more aspects of the subject disclosure include a non-transitory machine-readable medium, comprising executable instructions that, when executed by a processing system including a processor, facilitate performance of operations. The operations can include obtaining data regarding one or more local networks. Further, the operations can include receiving information from an AIC that is associated with one or more access networks, wherein the one or more access networks provide network connectivity for a user device, and wherein the information identifies conditions relating to the one or more access networks. Further, the operations can include selecting a local network of the one or more local networks to provide the network connectivity for the user device based on the data, the information, and a policy that is provided by an SMO system, resulting in a selected local network. Further, the operations can include causing the user device to utilize the selected local network to obtain the network connectivity.

One or more aspects of the subject disclosure include a method. The method can comprise receiving, by a processing system of a user device including a processor, and from an intelligent controller that is associated with a plurality of local networks, an instruction to select a first local network of the plurality of local networks to provide connectivity for the user device, wherein the instruction is accompanied by a first user policy. Further, the method can include obtaining, by the processing system, a second user policy that specifies use of a second local network of the plurality of local networks to provide the connectivity for the user device. Further, the method can include prioritizing, by the processing system, the second user policy over the first user policy by selecting the second local network to provide the connectivity for the user device.

### Other embodiments are described in the subject disclosure.

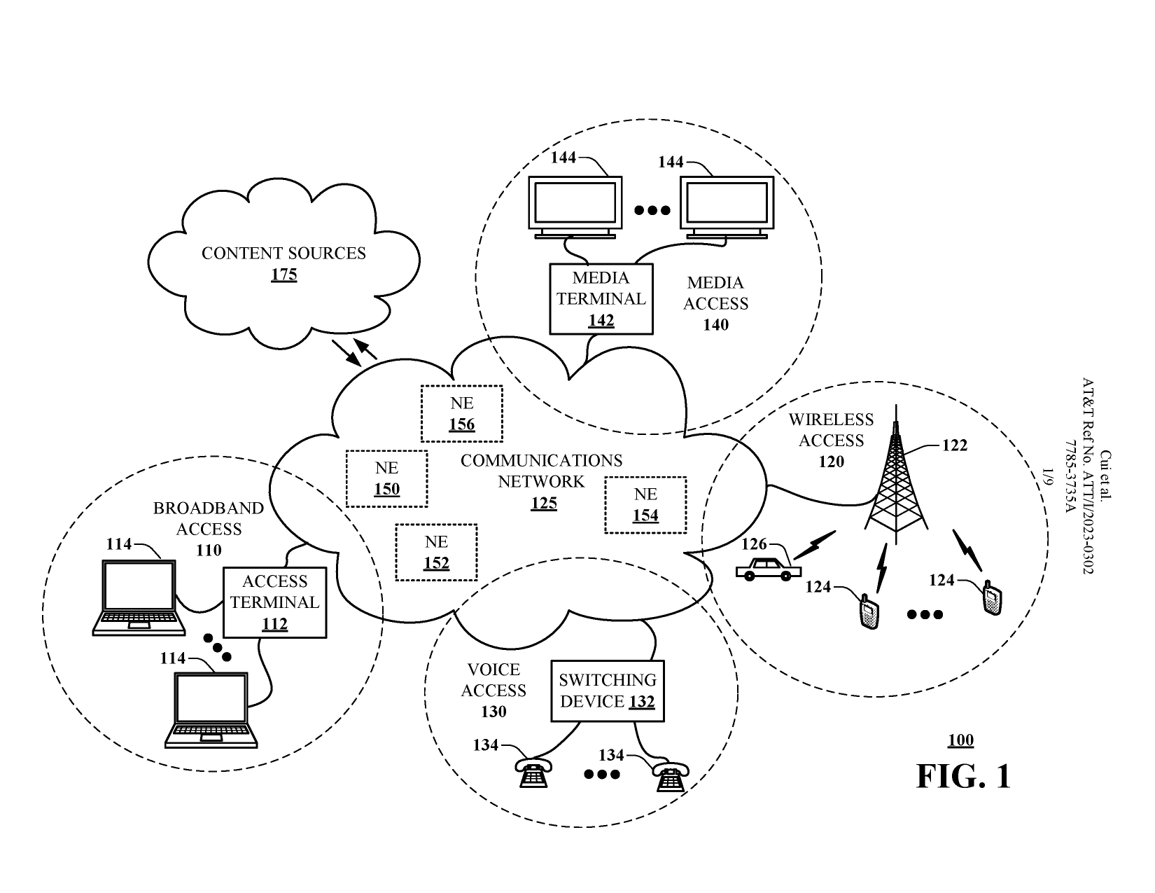

Referring now to FIG. 1, a block diagram is shown illustrating an example, non-limiting embodiment of a system 100 in accordance with various aspects described herein. For example, system 100 can facilitate, in whole or in part, E2E dynamic network/resource slicing and selection. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or another communications network.

In various embodiments, the access terminal 112 can include a digital subscriber line access multiplexer (DSLAM), cable modem termination system (CMTS), optical line terminal (OLT) and/or other access terminal. The data terminals 114 can

include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

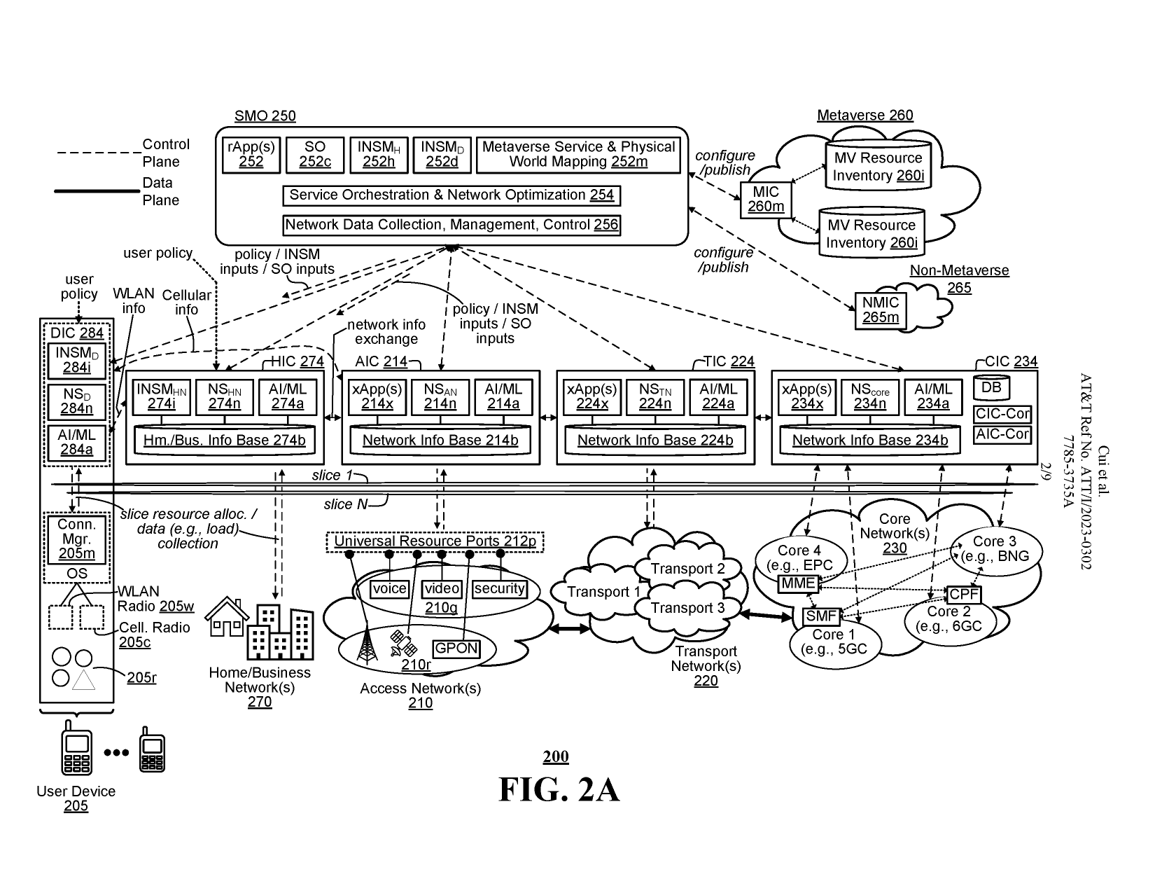

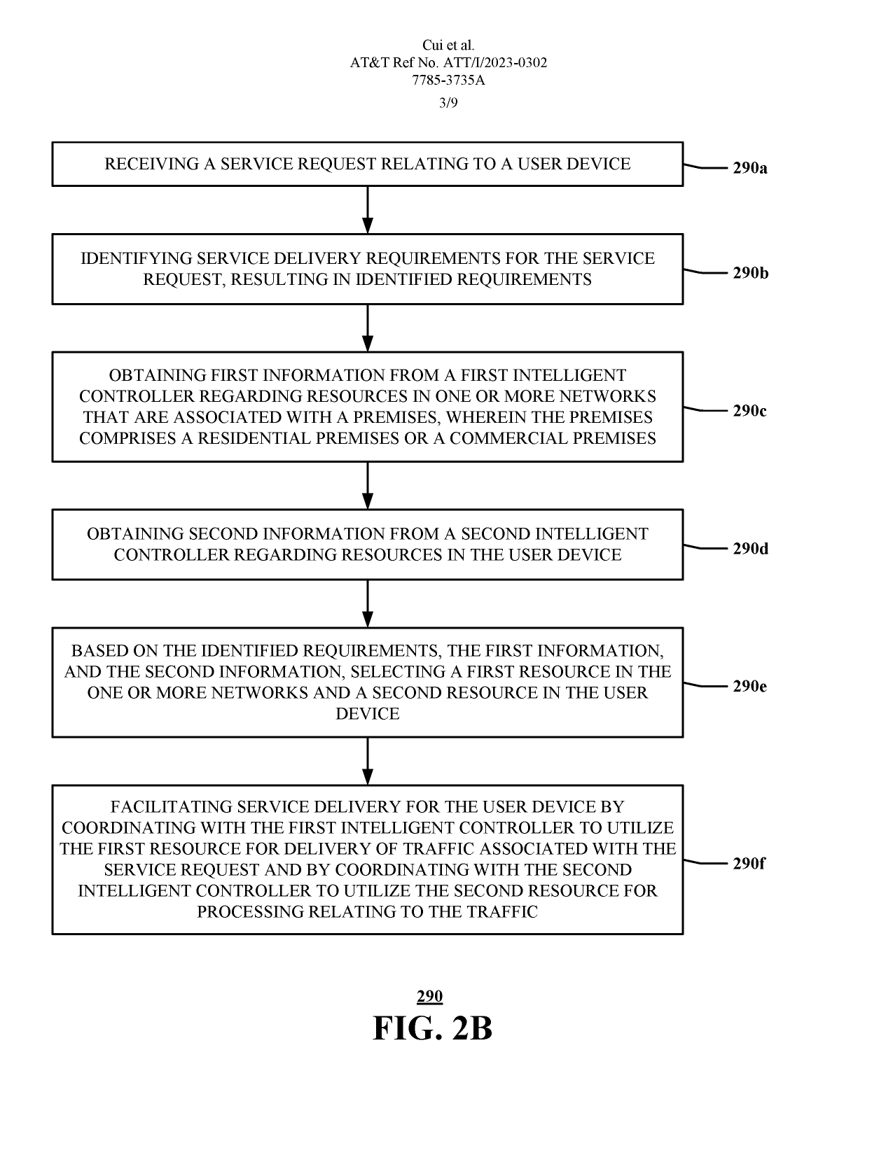

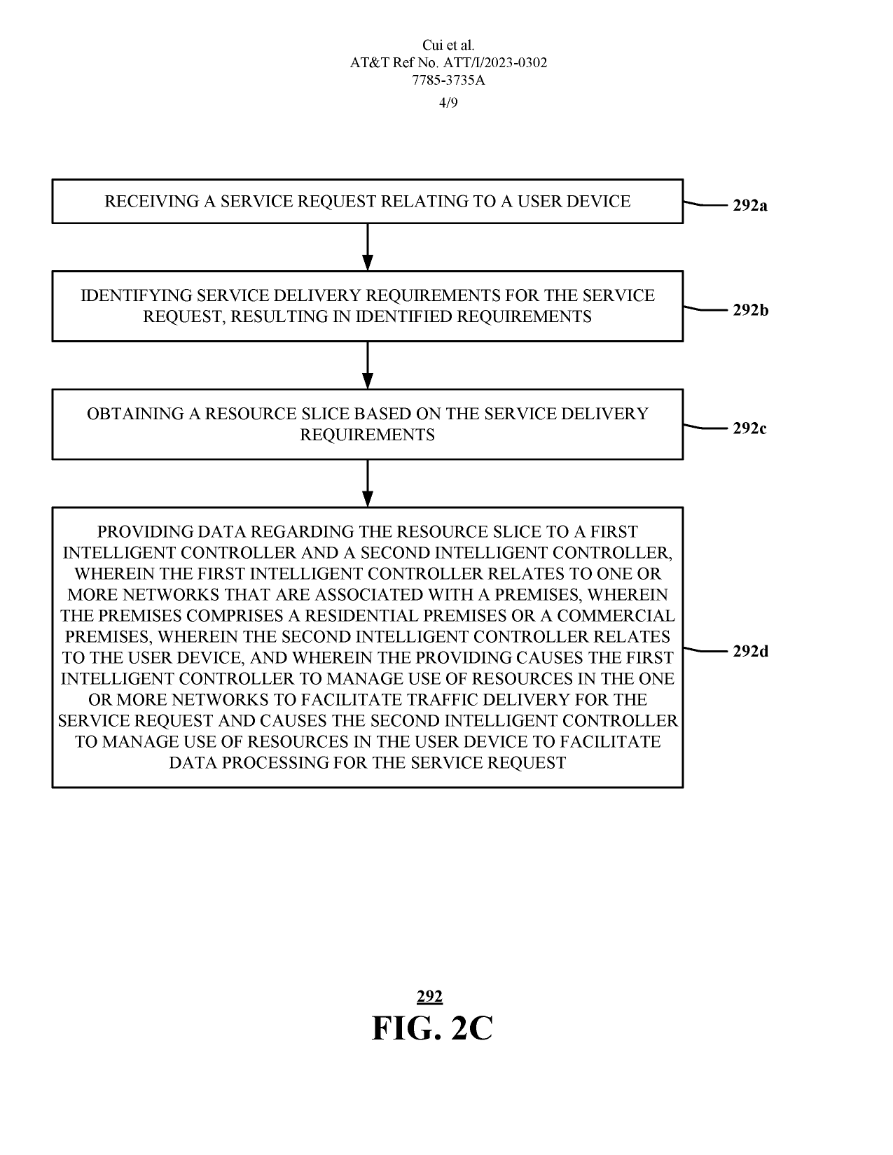

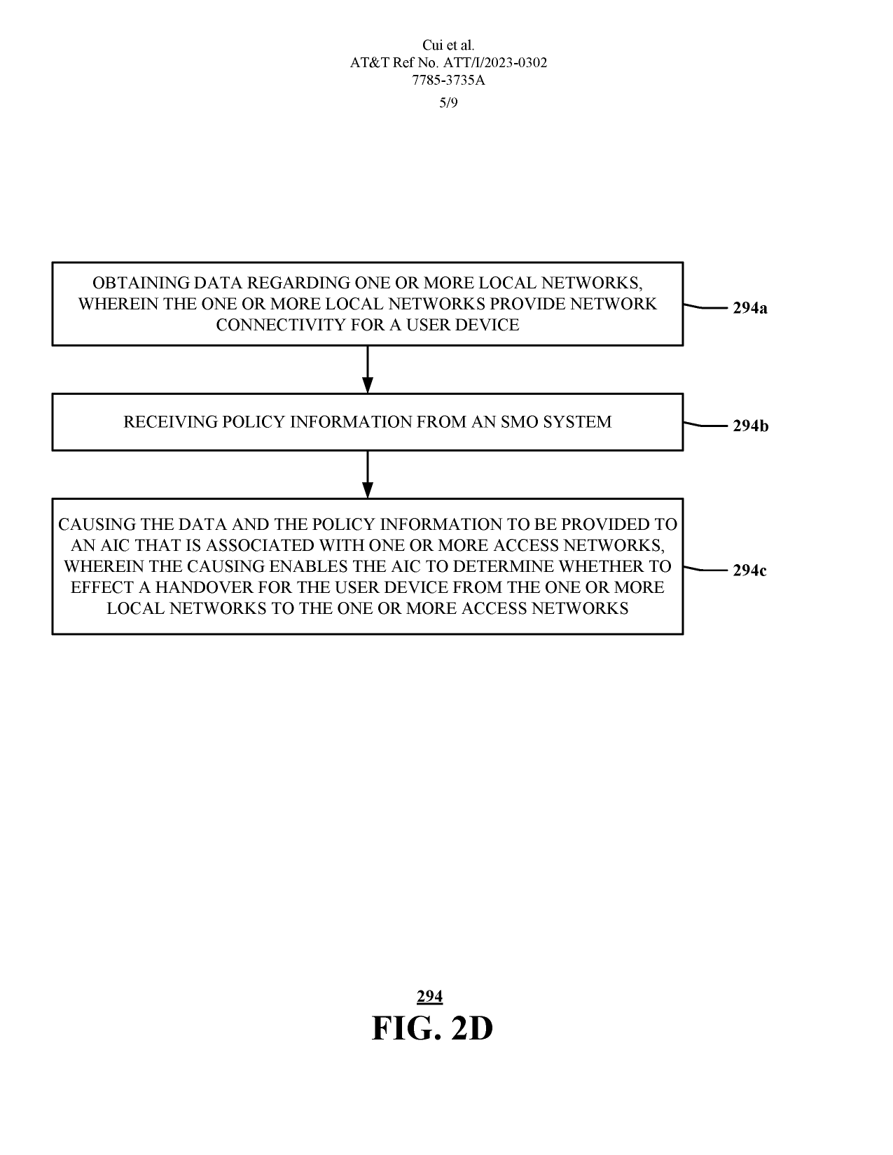

FIG. 2A is a block diagram illustrating an example, non-limiting embodiment of a system 200 functioning within, or operatively overlaid upon, the communications network 100 of FIG. 1 in accordance with various aspects described herein. The network system 200 may include access network(s) 210 (e.g., wireless RAN(s), Wi-Fi network(s), and/or wireline network(s)), transport (or backhaul) network(s) 220, core network(s) 230, home/business (or residential/commercial) network(s) 270, and user device(s) 205.

The access network(s) 210 may include network resources, such as one or more physical resources (or network nodes) 210r and one or more logical resources 210g. The physical resources 210r may include base station(s), such as one or more eNodeBs (eNBs), one or more gNodeBs (gNBs), and/or the like. In various embodiments, the physical resources 210r may additionally, or alternatively, include one or more satellites and/or uncrewed aerial vehicles (UAVs), one or more Gigabyte Passive Optical Networks (GPONs) and/or related components (e.g., Optical Line Terminal(s) (OLT), Optical Network Unit(s) (ONU), etc.), and/or the like. A base station may employ any suitable radio access technology (RAT), such as long term evolution (LTE), 5G, 6G, or any higher generation RAT. In various embodiments, the access network(s) 210 can include various types of heterogeneous cell configurations with various quantities of cells and/or types of cells. The logical resources 210g may include voice service system(s) (e.g., a hardware and/or software implementation of voice-related functions), video service system(s) (e.g., a hardware and/or software implementation of video-related functions, such as coder-decoder or compression-decompression (CODEC) components or the like), security service system(s) (e.g., a hardware and/or software implementation of security-related functions), and/or the like.

The access network(s) 210 may be in communication with the core network(s) 230 via intermediate links provided by the backhaul or transport network(s) 220. The transport network(s) 220 may include traditional transport network technologies, such as optical fibers, microwave links, wireless point-to-point technologies, etc. In some embodiments, the transport network(s) 220 may additionally, or alternatively, include access-based technologies, such as PON, Integrated Access Backhaul (IAB), etc. In certain embodiments, the transport network(s) 220 may additionally, or alternatively, include core-based technologies, such as an evolved packet core (EPC) (associated with a mobility management entity (MME)), a 5G core (5GC) (associated with an SMF), a 6G core (6GC) (associated with a control plane function (CPF)), and/or a Broadband Network Gateway (BNG).

The core network(s) 230 may include various network devices and/or systems that provide a variety of functions. Examples of functions provided by, or included, in the core network(s) 230 include an access mobility and management function (AMF) configured to facilitate mobility management in a control plane of the network system 200, a User Plane Function (UPF) configured to provide access to a data network (such as a packet data network (PDN) in a user (or data) plane of the network system 200), a Unified Data Management (UDM) function, a SMF, a Policy Control Function (PCF), and/or the like. For instance, the core network(s) 230 may include an EPC, a 5GC, a 6GC, and/or a BNG. In various embodiments, the core network(s) 230 may include one or more devices implementing other functions, such as a master user database server device for network access management, a PDN gateway server device for facilitating access to a PDN, and/or the like. The core network(s) 230 may be in further communication with one or more other networks (e.g., one or more content delivery networks (CDNs)), one or more services, and/or one or more devices. In one or more embodiments, some or all of the core network(s) 230 may be distributed cores.

The home/business network(s) 270 may include various network resources and devices that facilitate connectivity and communication within a local environment, such as a home or business setting. These networks 270 may encompass both wired and wireless technologies. In various embodiments, a home/business network 270 may include a gateway, which may act as the central hub for connecting various devices to the Internet and other external networks. The gateway may be a router, a modem, and/or an integrated access device (IAD) that supports multiple communication protocols, such as Wi-Fi, Ethernet, and broadband. A home/business network 270 may include various Local Area Network (LAN) components, such as switches, access points, and network extenders, that facilitate connectivity throughout the (residential or commercial) premises by distributing network traffic for connected devices. In a business or commercial setting, a home/business network 270 may include components such as enterprise-grade routers, firewalls, virtual private network (VPN) gateways, and/or network management systems.

In one or more embodiments, a home/business network 270 may include smart IoT devices, such as smart thermostats, smart lighting systems, smart security cameras, smart speakers, and/or other devices that may enhance the automation and control of home or business environments. These IoT devices may communicate with the gateway and may be managed through a central home automation platform.

It is to be understood and appreciated that the network system 200 can include any number/type of access network (e.g., any number/type of physical resources 210r and/or logical resources 210g), any number/type of transport network (e.g., any number/type of intermediate links), any number/type of core network (e.g., any number/type of cores, interfaces, etc.), any number/type of home/business network, and thus the number/types of these networks and their components illustrated in, or described with respect to, FIG. 2A are for illustrative purposes only.

User devices 205 may include user equipment (UEs), such as a communication and/or computing device, which may include a mobile phone (e.g., a smart phone, a radiotelephone, etc.), a desktop computer, a laptop computer, a tablet computer, a handheld computer, a display device, a gaming device, a wearable communication device (e.g., a smart wristwatch, a pair of smart eyeglasses, augmented reality (AR)-/virtual reality (VR)-/mixed reality (MR)-related gear (e.g., a pair of glasses or googles, a headset, a hat, glove(s), a mask, a jacket, a sock or shoe, a pair of pants or shorts, headphones, and/or the like), etc.), a similar type of device, or a combination of some or all of these devices. The user devices 205 can be equipped with one or more transmitter (Tx) devices and/or one or more receiver (Rx) devices configured to communicate with, and utilize network resources of, the network system 200.

A user device 205 may include various hardware and/or software resources 205r, such as processing units (e.g., one or more computer processing units (CPUs) and/or graphics processing units (GPUs)), one or more memories (e.g., random-access memories, solid-state drives (SSDs) or hard disk drives (HDDs), etc.), network interface cards (NICs), network management systems, or the like. A user device 205 may include various sensors and/or interfaces that enable interaction with a user and the surrounding environment. For instance, a user device 205 may include a touchscreen interface, cameras, microphones, and other input/output components. The user device 205 may include one or more radios

for network connectivity, such as a Wireless Local Area Network (WLAN) radio 205w and/or a cellular radio 205c, and may include a network connection manager 205m that is configured to manage these radios. For example, the network connection manager 205m may coordinate switching between the radios so as to ensure that the device remains connected to a suitable (or the most suitable) network based on signal strength, bandwidth availability, and/or other network conditions.

The metaverse 260 may include or may be associated with metaverse resource inventories 260i. Each metaverse resource inventory 260i may be implemented as a data structure (e.g., a database or the like) that stores information regarding (e.g., all relevant) metaverse objects of an immersive environment or experience. A metaverse object (i.e., an immersion) may include one or more user-interactable AR-, VR-, or MR-based constructs (e.g., three-dimensional (3D) graphic(s)/item(s), video object(s), audio object(s), and/or the like) that are designed to provide an immersive user experience, whether in the context of a game, a meeting, or other types of user-based interactions. For example, a metaverse object may include a virtual character or pathway that, when engaged by a user, interacts with the user (e.g., moves or talks with the user) and/or leads the user into an immersion (e.g., guides the user along a route, transitions the immersive environment to a different room or place, shows the user a video, etc.). As another example, a metaverse object may include a resource (e.g., a racecar, a weapon, etc.) that a user may control or manipulate in an immersive environment to achieve a goal. As yet another example, a metaverse object may include an icon or FIGURE(e.g., an avatar) that represents a real user in a virtual world. In the metaverse, there may be numerous metaverse objects that are available for user engagement and/or control.

In exemplary embodiments, the aforementioned information in a given metaverse resource inventory 260i may include, for each relevant metaverse object, data regarding an identifier or ID of the metaverse object, a classification of the metaverse object (e.g., as a representation of a user (such as an avatar), as a resource usable by a user (such as a racecar in a game), etc.), location(s) of the metaverse object within the immersive environment (e.g., in 3D space identified using cartesian coordinates (x, y, and z)), a state of mobility of the metaverse object in the immersive environment (e.g., an avatar “walking” 2 meters per second in the metaverse, a racecar traveling at 100 kilometers per

second in the metaverse, etc.), service-dependent geographic area(s) or location(s) (e.g., multi-access edge computing (MEC) devices) where instances of the metaverse object (such as software resources and/or other metaverse object data) are stored and accessible, a community or communities (or “geo area(s)”) with which the metaverse object is associated (e.g., a golfing community for a golfer avatar in a golfing game in the metaverse, a racing community for a racecar resource in a racing game in the metaverse, etc.), the minimum and/or recommended connection bandwidth or speed for experiencing the metaverse object, the “best” frame rate for experiencing the metaverse object, the minimum and/or recommended extended reality (XR) device (processing, memory, graphics, network communications, etc.) capabilities for experiencing the metaverse object, dimensions of the metaverse object and/or characteristics or other parameters associated with the metaverse object, the possible types of interactions with the metaverse object (e.g., gesture-based interactions, voice-based interactions, etc.), the type or theme of the metaverse object (e.g., for play, for entertainment, for education, etc.), the complexity or sophistication level of the metaverse object (e.g., for beginners, for intermediate-level users, for advanced users, etc.), the inputs that are accepted by the metaverse object (e.g., types of commands, types of requests, etc.), the outputs that the metaverse object may provide (e.g., video presentations, monetary rewards, lead-ins or triggers to join other immersions, etc.), and/or the like.

The metaverse 260 may be associated with one or more metaverse service providers. A given metaverse service provider may operate one or more immersion engine(s) (e.g., associated with one or more metaverse resource inventories 260i) that are implemented in server device(s) (not shown) and configured to provide functions or capabilities relating to facilitating and managing immersive environments or experiences for users. In various embodiments, an immersion engine may provide AR environments, VR environments, or a combination of both in the metaverse. Thus, metaverse services facilitated by the network system 200 can be purely virtual and/or can involve interactions between the virtual and physical worlds.

As a given immersive experience or environment may involve multiple metaverse objects and possibly those that correspond to users located in different geographic locations and using network connectivity provided by different network

providers, aspects of the immersion or immersive environment (such as metaverse object data, associated object or immersive environment data (e.g., graphics, audio, etc.), software for providing the immersive environment or metaverse object data, etc.) may be hosted or stored in servers or computing devices that are generally local or regional to those users. For instance, a virtual racing game or party hosted in the metaverse 260 may include metaverse objects (e.g., racecars or avatars) that are associated with users in different countries and that are respectively hosted in or run on one or more edge systems/devices near the corresponding users. Thus, although not shown, in exemplary embodiments, the network system 200 may include any number of edge systems/devices associated with base stations of the access network(s) 210. In various embodiments, the base stations and corresponding edge systems may be associated with (e.g., respective) cells, such as heterogeneous cells (e.g., that provide access to the network system 200 using different types of RATs). In various embodiments, the cells can be terrestrial cells (e.g., one or more macrocells, small cells or microcells, Wi-Fi-based cell(s), or the like) or non-terrestrial cells (e.g., a flying cell, or drone cell, served by UAVs). The network system 200 can include various quantities of cells (e.g., primary cells and/or secondary cells), various quantities of base stations in a cell, and/or various types of base stations and/or cells. User devices 205 can be located within cell coverage areas of the network system 200, provided by cells associated with the base stations, and may travel amongst various ones of the cells.

As depicted in FIG. 2A, the network system 200 may include an access network intelligent controller (AIC) 214 that interfaces an SMO system 250 and the access network(s) 210. In various embodiments, the AIC 214 may be capable of providing real-time (or near real-time) microservices associated with the access network(s) 210, and may be leveraged to select the (e.g., most appropriate) access technology or technologies that meet the needs of requested services.

The AIC 214 may include one or more applications (xApps) 214x, a network selection for access network (NS_{AN}) system 214n (which may be implemented in an xApp as well), an AI/ML system 214a (which may be implemented in an xApp as well), and a network information database 214b. The AI/ML system 214a may be configured to analyze (e.g., real-time or near real-time) network conditions in the access network(s) 210 and predict future network states to improve (or optimize or approximately optimize)

resource allocation and service delivery. The AI/ML system 214a may utilize ML algorithms to identify patterns and anomalies in network traffic across the access network(s) 210 to enable proactive management and self-healing of the network(s). The NSAN system 214n may utilize the predictions from the AI/ML system 214a to select particular physical resources 210r and/or logical resources 210g for service delivery. The network information database 214b may store information regarding the various physical resources 210r and/or logical resources 210g, including information regarding load conditions associated with those resources, availability of those resources, and/or the like; some or all of this information may be accessible to the xApp(s) 214x, the AI/ML system 214a, and/or the NSAN system 214n.

Although not illustrated in FIG. 2A, in certain embodiments, portion(s) of the access network(s) 210 may be, or may include, a virtual RAN (vRAN) (e.g., in an O-RAN-based implementation) in which software is decoupled from hardware and implementation thereof is in accordance with principles of network function virtualization (NFV), where the control plane is separated from the data plane. In these embodiments, the vRAN may include a centralized set of baseband units located remotely from antennas and remote radio units, may be configured to share signaling amongst cells, and may provide control and service delivery optimization (or approximate optimization) functions. Here, the AIC 214 may include RIC functionality—i.e., a second RIC portion that is at least partially implemented in the xApps 214x, including, for instance, the NS_{AN} system 214n and/or the AI/ML system 214a. In various embodiments, the AIC 214 may coordinate with a first RIC portion that is implemented, or otherwise incorporated, in a network service management platform (e.g., such as in one or more RAN applications (rApps) in the SMO system 250 and/or another system). The AIC 214 may include a second RIC portion having a centralized unit (CU) (e.g., a base station CU, such as a gNB CU or the like) that provides a CU applications layer as well as a CU control plane CU-CP and a CU user plane CU-UP. The particular functions performed by the two RIC portions can vary based on various criteria, including requirements of the network, and can also include redundancy and/or dynamic switching of functions (including functions described herein) between the two RIC portions. Additionally, the vRAN may include distributed units (DUs)—i.e., baseband units (e.g., base station DUs, such as gNB DUs or the like)

configured to perform signal processing, user equipment (UE) scheduling, and/or the like, where each of DUs may be implemented as a virtual DU (vDU). Further, the vRAN may also include remote radio heads or remote units (RUs) for communicative coupling (e.g., via an air interface) with the user devices 205. The RUs, the DUs, and the CU may, by way of a fronthaul (e.g., having open standards, such as O-RAN standards or the like), a midhaul, and a backhaul (e.g., portion(s) of the transport network(s) 220), provide (e.g., controlled) connectivity between the user devices 205 and (e.g., portion(s) of) the core network(s) 230. The network service management platform and/or the first RIC portion may be operative at or in non-real-time; the second RIC portion and/or the CU may be operative at or in near-real-time; and the DUs, the RUs, and/or the user devices 205 may be operative at or in real-time. As the terms (and related terms) are used herein, real-time operations may occur over a span of fractions of a second up to a second (or the like), near-real-time operations may occur over the course of a few seconds (e.g., 1 to 5 seconds or the like), and non-real-time operations may occur over a time period that is greater than a few seconds (e.g., greater than 5 seconds or the like). The network service management platform may manage, or otherwise adapt, RIC behaviors and/or operations across one or more of the three time zones or timeframes described above (e.g., real-time, near-real-time, and non-real-time) on an individualized and/or collective basis. Such management or adaptation of RIC behaviors and/or operations may conform to one or more models or microservices (e.g., AI models or microservices), as described herein. In turn, the RIC portions may establish and/or modify policies and/or behaviors of respective CUs, DUs, and RUs in accordance with the model(s) or microservice(s). In this regard, the network service management platform may indirectly influence the behaviors and/or operations of CUs, DUs, and/or RUs via one or more of the RIC portions. The communication channels and/or links between the vRAN and the user devices 205 may include wireless links. For example, some or all of the user devices 205 may be mobile, and may therefore enter and/or exit a service or coverage area associated with the vRAN. Also, some of the user devices 205 may include non-mobile or stationary devices. The vRAN may thus include one or more routers, gateways, modems, cables, wires, and/or the like, and the communication channels and/or links between the vRAN and the non-mobile or stationary user devices 205 may include wired/wireline links, optical links, etc. In certain embodiments, the

second RIC portion may store, execute, and/or deploy in or via an applications layer (e.g., the aforementioned CU applications layer), applications or microservices (e.g., the xApps 214x or the like) that are configured to control and manage the vRAN. The applications or microservices may relate to scheduler capacity optimization, coverage optimization, capacity optimization (including, for example, via interference mitigation), user quality optimization (including, for example, for an uplink (UL) and/or a downlink (DL)), radio connection management, mobility management, quality-of-service (QoS) management, interference management, and/or the like. One or more of the RIC portions may also be configured to execute, or otherwise deploy, models, such as AI (e.g., ML) models that, when executed in one or more containers, provide corresponding microservices. Deployment of a microservice, such as an AI model or microservice, in the RIC portion(s) may involve, or include, for example, executing or instantiating the AI model in one or more containers in the applications layer of the RIC (e.g., the aforementioned CU applications layer), such that the AI model processes inputs (e.g., received from other microservices running on the RIC and/or from various components of the vRAN, such as the CU-CP & CU-UP, the DUs, and/or the RUs) and provides outputs (e.g., to the other microservices and/or the various components of the vRAN), in accordance with the AI model, to control the overall operation of the vRAN. Examples of microservices provided by AI model(s) can include those relating to scheduler capacity optimization, coverage optimization, capacity optimization (including, for example, via interference mitigation), user quality optimization (including, for example, for the UL and/or the DL), telemetry, network traffic control and/or management, device admissions (e.g., UE admissions control), and/or the like.

In exemplary embodiments, the AIC 214 may not only have RIC-like functionality for managing wireless-based network resources, but may also have functionality for managing wireline-based network resources in a manner that supports wirelines wireless convergence (WWC). In this sense, the AIC 214 may thus operate as a “general” access network controller.

As illustrated in FIG. 2A, the network system 200 may also include a transport network intelligent controller (TIC) 224 that interfaces the SMO system 250 and the transport network(s) 220. In various embodiments, the TIC 224 may be capable of providing real-time (or near real-time) microservices associated with the transport network(s) 220, and may be leveraged to select the (e.g., most appropriate) transport network(s) or link(s) that meet the needs of requested services.

The TIC 224 may include one or more applications (xApps) 224x, a network selection for transport network (NS_{TN}) system 224n (which may be implemented in an xApp as well), an AI/ML system 224a (which may be implemented in an xApp as well), and a network information database 224b. The AI/ML system 224a may be configured to analyze (e.g., real-time or near real-time) network conditions in the transport network(s) 220 and predict future network states to improve (or optimize or approximately optimize) resource allocation and service delivery. The AI/ML system 224a may utilize ML algorithms to identify patterns and anomalies in network traffic across the transport network(s) 220 to enable proactive management and self-healing of the network(s). The NS_{TN} system 224n may utilize the predictions from the AI/ML system 224a to select particular physical resources for service delivery. The network information database 224b may store information regarding the various physical resources, including information regarding load conditions associated with those resources, availability of those resources, and/or the like; some or all of this information may be accessible to the xApp(s) 224x, the AI/ML system 224a, and/or the NS_{TN} system 224n.

As illustrated in FIG. 2A, the network system 200 may also include a core network intelligent controller (CIC) 234 that interfaces the SMO system 250 and the core network(s) 230. In various embodiments, the CIC 234 may be capable of providing real-time (or near real-time) microservices associated with the core network(s) 230 (which may include distributed cores), and may be leveraged to select the (e.g., most appropriate) core network(s) or instance(s) that meet the needs of requested services. In one or more embodiments, the CIC 234 may be configured with (e.g., operator specified or intended) policies and control functions for core network optimization (or approximate optimization) and efficiency/flexibility and for managing quality of experience (QoE).

The CIC 324 may include one or more applications (xApps) 234x, a network selection for core network (NS_{CORE}) system 234n (which may be implemented in an xApp as well), an AI/ML system 234a (which may be implemented in an xApp as well), and a network information database 234b. The AI/ML system 234a may be configured to

analyze (e.g., real-time or near real-time) network conditions in the core network(s) 230 and predict future network states to improve (or optimize or approximately optimize) resource allocation and service delivery. The AI/ML system 234a may utilize ML algorithms to identify patterns and anomalies in network traffic across the core network(s) 230 to enable proactive management and self-healing of the network(s). The NSCORE system 234n may utilize the predictions from the AI/ML system 234a to select particular physical resources for service delivery. The network information database 234b may store information regarding the various physical resources, including information regarding load conditions associated with those resources, availability of those resources, and/or the like; some or all of this information may be accessible to the xApp(s) 234x, the AI/ML system 234a, and/or the NSCORE system 234n.

The CIC 234 may also include a CIC coordinator (CIC-Cor) that is configured to communicate with other CICs (not shown), an AIC coordinator (AIC-Cor) that is configured to communicate with the AIC 214, and one or more databases (DB) for storing various data. The AIC-Cor may facilitate service coordination between the CIC 234 and the AIC 214 as needed.

As illustrated in FIG. 2A, the network system 200 may also include a metaverse intelligent controller (MIC) 260m that interfaces the SMO system 250 and the MV resource inventories 260i. In various embodiments, the MIC 260m may be capable of communicating with the metaverse resource inventories 260i to retrieve data relating to immersive environments and/or metaverse objects in those immersive environments.

As illustrated in FIG. 2A, the network system 200 may also include an HIC 274. The HIC 274 may be implemented in a micro-services framework that allows for modular and scalable management of home/business network(s) 270. The HIC 274 may be configured to collect data on network traffic conditions and interface with the SMO system 250 for resource allocation purposes. The HIC 274 may be integrated into a gateway or a router that provides centralized control and management of the home/business network(s) 270. In one or more embodiments, the HIC 274 may be configured to communicate (and exchange information) with the AIC 214 regarding network load and resource availability so as to facilitate coordinated resource selection/management between the home/business and access network segments.

The HIC 274 may include microservices, such as a home network slicing (NS_{HN}) function or system 274n and an intelligent network selection and mobility (INSM_{HN}) function or system 274i. Some or all of these microservices may be implemented in one or more xApp(s).

The NS_{HN} system 274n may be configured to provide network slicing control for home/business network(s) 270, enabling dynamic allocation of network resources based on service requirements and/or the requirements of different applications and devices. The NS_{HN} system 274n may coordinate with an SO (rApp-based) system 252c in the SMO system 250 that facilitates E2E network slicing control across the various domains, such as the access network(s) 210, the transport network(s) 220, the core network(s) 230, the home/business network(s) 270, and the user device(s) 205.

Network slicing allows for the creation of multiple virtual networks on top of a shared physical infrastructure. Each slice can be customized to provide different levels of performance, security, and service quality, depending on the needs of the application or user. The physical resources within the various network domains, such as frequency ranges, time slots, bandwidth, and processing power, may be allocated to different slices to ensure that specific requirements are met. For example, a slice that is dedicated to real-time video conferencing may be allocated more bandwidth and lower latency compared to a slice that is used for general web browsing.

In various embodiments, the NS_{HN} system 274n may manage the allocation of physical resources within the home/business network(s) 270. Similarly, the AIC 214 may include functionality for managing the access network segment (which may include resources such as frequency ranges and time slots for wireless communication), the TIC 224 may include functionality for managing the transport network segment (which may include resources relating to data transmission across the transport network(s) 220), the CIC 234 may include functionality for managing the core network segment (which may include resources for data processing and routing within the core network(s) 230), and/or the DIC 284 may include functionality (described in more detail below) for managing slicing functions on end user devices, such as user device(s) 205.

By coordinating these allocations across different segments, the SMO system 250 can create E2E slices that provide tailored services for specific applications or users. For instance, the SO system 252c may receive data from the NS_{HN} system 274n regarding resource availability and traffic conditions in the home/business network(s) 270. Based on this data, the SO system 252c can dynamically adjust resource allocations to ensure that each slice meets its unique requirements, such as low latency for real-time applications or high bandwidth for data-intensive services. This advantageously enhances overall user experience by ensuring that network resources are (e.g., optimally or approximately optimally) utilized and that service quality is maintained across all network segments.

In one or more embodiments, the NS_{HN} system 274n or another system in the HIC 274 may collect (e.g., real-time or near real-time) data regarding resources (e.g., availability, load, capabilities, etc.) in the home/business network(s) 270 as well as information regarding traffic conditions, and may provide some or all of this data to the SO system 252c for network slicing orchestration purposes. The SO system 252c may provide slicing requirements (e.g., slice ID, service level agreement (SLA), etc. for each slice) and/or policy information (e.g., throughput, latency, and QoS requirements, and/or the like) to the NS_{HN} system 274n, which the latter may utilize to dynamically adjust allocations of resources in the home/business network(s) 270. Policy information may include network operator intent, such as prioritization of certain types of traffic during peak hours. In one or more embodiments, the NS_{HN} system 274n may be configured to receive user policy information, such as user preferences for using a particular Wi-Fi spectrum of a given Wi-Fi network, etc. As an example, the user policy may be to use Wi-Fi spectrum range X of Wi-Fi network #1 for online gaming applications. As another example, the user policy may be to use Wi-Fi spectrum range Y of Wi-Fi network #2 for messaging applications. The NS_{HN} system 274n may receive user policy information from a user device 205 via a management interface of the HIC 274. The user device 205 may access this management interface through a web-based portal or a dedicated application that allows users to specify their preferences and policies, which may be communicated to the NS_{HN} system 274n for implementation.

The INSM_{HN} system 274i may be configured to provide intelligent network selection and mobility decisions for user device(s) 205 with respect to their network access via the home/business network(s) 270. The INSM_{HN} system 274i or another system in the HIC 274 may collect (e.g., real-time or near real-time) data regarding its underlying

home/business network(s) 270, and may utilize some or all of this data for dynamic network selection and mobility handover purposes. Such data may identify available Wi-Fi network(s), their capabilities, their signal strength(s) (e.g., as reported by user device(s) 205), their network congestion level(s), and/or other information regarding those network(s). The INSMHN system 274i may cause the HIC 274 to provide some or all of this data to the AIC 214. Conversely, the AIC 214 may similarly provide (e.g., real-time or near real-time) data regarding its underlying access network(s) 210. Such data may identify available physical resources 210r (e.g., gNBs or the like), their capabilities, their signal strength(s) (e.g., as reported by user device(s) 205), their network congestion level(s), and/or other information regarding those physical resources 210r. The INSMHN system 274i may coordinate with an INSMH (rApp-based) system 252h in the SMO system 250 that is configured to manage or control overall network selection and mobility handovers between the HIC 274 and the AIC 214. The INSMH system 252h may provide control/policy information to the HIC 274 for use by the INSMHN system 274i when deciding on handovers. Such control/policy information may include network operator intents—e.g., prioritization of usage of Wi-Fi network(s) over 5G or 6G network(s) (or vice versa) for certain types of traffic during certain hours of the day, preference for using a certain Wi-Fi network for one type of application and another Wi-Fi network for another type of application. As an example, the operator policy may be to utilize Wi-Fi network #1 for online gaming traffic. As another example, the operator policy may be to utilize Wi-Fi network #2 for web browsing application traffic. The INSMHN system 274i may also receive user policy information, such as user preferences for Wi-Fi over cellular networks or preferences for cellular network when using certain applications or streaming, which may be inputted via the above-described management interface of the HIC 274. In certain embodiments, the INSMHN system 274i may prioritize a user policy over a policy provided by the INSMH system 252h. In other embodiments, the INSMHN system 274i may prioritize a policy provided by the INSMH system 252h over a user policy.

The INSM_{HN} system 274i and the AIC 214 may coordinate to provide intelligent mobility enhancements for user device(s) 205 that move into (e.g., indoor) areas served by home/business network(s) 270 and out into (e.g., outdoor) areas that such home/business network(s) 270 may not provide sufficient or any coverage for and thus are better served by access network(s) 210.

For instance, the AIC 214 may (acting as a serving controller for a user device 205) detect when a user device 205 is located outdoors but is moving towards or into an indoor environment based on mobility information received from the user device 205 and/or the HIC 274, such as the INSM_{HN} system 274i. As an example, the AIC 214 may exchange information with the INSM_{HN} system 274i (such as by obtaining home/business network-related data from the INSM_{HN} system 274i) to identify home/business network conditions, and may decide whether to maintain the cellular connection for the user device 205’s ongoing application or to effect a handover with the HIC 274 to switch the connection to a Wi-Fi network based on the exchanged information. This decision may be based on factors such as signal strength, network congestion, and/or application requirements.

As another example, the HIC 274 may (acting as the serving controller for a user device 205) detect when the user device 205 is located indoors but is moving towards or into an outdoor environment. The HIC 274, such as the INSMHN system 274i, may detect the user device’s mobility and compare Wi-Fi and cellular RF signal levels. The HIC 274 may exchange information with the AIC 214 to assist in the mobility handover process. For example, the INSMHN system 274i may provide data to the AIC 214 regarding the current Wi-Fi signal strength, network congestion, and other relevant conditions. The INSMHN system 274i may additionally provide, to the AIC 214, policy information that the INSMHN system 274i has previously received from the SMO system 250. Policy information may identify, for instance, criteria for selecting an access network over a home/business network to provide connectivity for the user device 205 and/or criteria for selecting a home/business network over an access network to provide connectivity for the user device 205. As an example, the policy information may require that, during particular times of day or for particular types of traffic, an access network (and not a home/business network) is to provide connectivity for the user device 205. Based on the exchanged information, the AIC 214 may determine a time and/or conditions for effecting a handover of the connection from the home Wi-Fi network to the cellular network so as to ensure that the user device 205 maintains a stable and reliable connection as it transitions to the outdoor environment. This decision may be based on factors such as signal strength, network congestion, application requirements, and/or policy information.

The HIC 274 may include an AI/ML system 274a (which may also be implemented in an xApp) that is configured to analyze network traffic patterns and predict future network conditions. The AI/ML system 274a may be trained to output predictions of network congestion levels, and may provide these predictions to the NS_{HN} system 274n to facilitate dynamic slice resource allocation by the NS_{HN} system 274n. For example, the AI/ML system 274a may be trained to predict times when network usage exceeds a specific threshold, which the NS_{HN} system 274n can use to allocate additional resources to slices that are expected to experience high demand during those periods. As another example, the AI/ML system 274a may be trained to predict bandwidth utilization trends, which the NS_{HN} system 274n can use to preemptively adjust resource allocations to maintain performance above desired thresholds. As a further example, the AI/ML system 274a may be trained to predict latency spikes, which the NS_{HN} system 274n can use to reallocate resources to reduce or minimize delays for known latency-sensitive applications, such as real-time video conferencing or online gaming.

The AI/ML system 274a may additionally, or alternatively, be trained to output predictions of signal strength variations, and may provide these predictions to the INSM_{HN} system 274i to facilitate intelligent network selection and mobility decisions by the INSM_{HN} system 274i. For example, the AI/ML system 274a may be trained to predict signal degradation patterns and anomalies in network performance, which the INSM_{HN} system 274i can use to preemptively switch user devices to more stable connections or networks (i.e., a second Wi-Fi network with higher signal strength or that has signal strength that is above a threshold). As another example, the AI/ML system 274a may be trained to predict areas of high interference, which the INSM_{HN} system 274i can use to reroute connections to less congested channels. As a further example, the AI/ML system 274a may be trained to predict handover failure rates, which the INSM_{HN} system 274i can use to improve (or optimize or approximately optimize) handover decisions and improve connectivity stability.

As illustrated in FIG. 2A, the network system 200 may also include a DIC 284. The DIC 284 may be implemented in one or more applications or platforms that are executed within a user device 205, and may be configured to manage the selection and usage of resources within the user device 205 as well as the selection of network connectivity for the user device 205. The DIC 284 may include microservices, such as a network slicing device (NS_{D}) function or system 284n and an intelligent network selection and mobility (INSM_{D}) function or system 284i. Some or all of these microservices may be implemented in one or more applications.

The NS_{D} system 284n may be configured to provide resource slicing control for the user device 205, enabling dynamic allocation of device resources 205r based on service requirements and/or the requirements of different applications and network conditions. The NS_{D} system 284n may coordinate with the SO system 252c in the SMO system 250. The resources 205r within the user device 205 may include, for example, such as CPUs, CPU cycles, GPUs, GPU cycles, memory, battery power, radio interfaces, etc., which may be allocated to different slices in a manner that meets specific requirements. For example, a slice that is dedicated to a real-time video conferencing application may be allocated more CPU cycles compared to a slice that is used for general web browsing.

In one or more embodiments, the NS_{D} system 284n or another system in the DIC 284 may collect (e.g., real-time or near real-time) data regarding resources 205r (e.g., availability, load, capabilities, etc.) in the user device 205, and may provide some or all of this data to the SO system 252c for slicing orchestration purposes. The SO system 252c may provide slicing requirements (e.g., slice ID, SLA, etc. for each slice) and/or policy information (e.g., throughput, latency, and QoS requirements, and/or the like) to the NS_{D} system 284n, which the latter may utilize to dynamically adjust allocations of resources in the user device 205. For instance, high-priority video conferencing application traffic may be associated with a slice 1 that includes resource X (e.g., CPU cycles) and resource Y (e.g., memory) in the user device 205 to handle. As another example, AR application traffic may be associated with a slice N that includes resource W (e.g., GPU #1’s processing power) and a particular portion of resource Z (e.g., 40% of CPU #2’s processing power) to handle. In this way, user traffic with the Network Slice Selection Assistance Information (NSSAI) may be placed on the appropriate slice and supported in an E2E manner. The SO

system 252c may, in coordination with the NSD system 284n, ensure that the designated user device resources are used to process or handle such user traffic. Policy information may include network operator intent, such as prioritization of CPU or GPU usage for certain types of applications and/or traffic. As an example, the operator policy may be to prioritize use of CPU #2 of the user device 205 for video application traffic, but not use of CPU #1 of the user device 205 for the video application traffic. In one or more embodiments, the NSD system 284n may be configured to receive user policy information, such as user preferences for using more battery power for high-performance gaming, less battery power for background applications, more memory allocation for video editing, less memory allocation for simple tasks such as e-mail retrieval, a particular GPU for rendering graphics, another GPU for general processing, Wi-Fi channel X for streaming, Wi-Fi channel Y for browsing, and so on. The NSD system 284n may receive user policy information from a user device 205 via a management interface of the DIC 284. The user device 205 may access this management interface through a web-based portal or a dedicated application that allows users to specify their preferences and policies, which may be communicated to the NSD system 284n for implementation.

The INSM_{D} system 284i may be configured to facilitate intelligent network selection and mobility decisions for user device(s) 205 with respect to their network connectivity via the home/business network(s) 270 and the access network(s) 210. The INSM_{D} system 284i may coordinate with the INSM_{HN} system 274i of the HIC 274 and/or with the AIC 214 to facilitate identification and selection of the appropriate type of network to use for the connectivity. The INSM_{H} system 252h may provide control/policy information and/or data regarding home/business networks (e.g., WLAN signal coverage ranges, loads, capabilities, etc.) to the DIC 284 for analysis or consideration by the INSM_{D} system 284i. The control/policy information may include network operator intents, such as conditions under which the user device 205 should use Wi-Fi versus cellular or any other type of local network when available. Factors may include the type of application being used (e.g., video streaming, web browsing, gaming), the type of the user device 205 (e.g., smartphone, tablet, laptop), network and RF conditions (e.g., signal strength, interference levels, etc.), data speed requirements, and/or the mobility state of the user device 205 (e.g., stationary, moving, high-speed travel, etc.). The AIC 214 may provide data regarding access networks (e.g., cellular signal coverage ranges, loads, capabilities, etc.) to the DIC 284 for analysis or consideration by the INSM_{D} system 284i.

The INSM_{D} system 284i may also receive user policy information, such as user preferences for Wi-Fi over cellular networks or preferences for cellular network when using certain applications or streaming, which may be inputted via the above-described management interface of the DIC 284. In certain embodiments, the INSM_{D} system 284i may prioritize a user policy over a policy provided by the INSM_{H} system 252h. In other embodiments, the INSM_{D} system 284i may prioritize a policy provided by the INSM_{H} system 252h over a user policy. In any case, the user policy received by the INSM_{D} system 284i may be provided by the INSM_{D} system 284i to the INSM_{HN} system 274i of the HIC 274, and may be prioritized by the INSM_{HN} system 274i over a user policy that is received by the INSM_{HN} system 274i from the aforementioned management interface of the HIC 274. For instance, if a particular user policy that is inputted to the INSM_{D} system 284i via the management interface of the DIC 284 specifies a preference for using Wi-Fi for video streaming to conserve cellular data, but another user-imposed policy received from the INSM_{HN} system 274i (i.e., previously user-inputted via the management interface of the HIC 274) prioritizes cellular network usage for video streaming, the INSM_{D} system 284i may prioritize the particular user policy over the other user-imposed policy and instruct the connection manager 205m of the user device 205 to utilize the Wi-Fi radio 205w for the network connection.

In various embodiments, the NS_{HN} system 274n and the INSM_{HN} system 274i and the NS_{D} system 284n and the INSM_{D} system 284i of multiple user devices 205 may coordinate with one another such that resources 205r of different user devices and different networks are used to facilitate traffic delivery and data processing. For instance, the NS_{HN} system 274n and the INSM_{HN} system 274i and the NS_{D} system 284n and the INSM_{D} system 284i of the multiple user devices 205 may determine (e.g., based on a user policy, an operator policy, or a combination of such policies and/or based on network/user device resource availability/load/capabilities) to cause video traffic for a live streaming application that is running on a first user device 205 to be provided over a first Wi-Fi network to the first user device 205 for processing by GPU #3 (and not GPU #s 1 and 2), and to cause audio traffic for the live streaming application to be provided over a second

Wi-Fi network to a second user device 205 for output by a left speaker (and not a right speaker). In this case, a user may be able to experience the live stream using particular resources of two different user devices 205 and with different types of traffic (video and audio) being delivered to the two different user devices 205 over two different Wi-Fi networks.

Although not shown, the network system 200 may include an access resource abstraction layer or system that is configured to provide abstractions of the physical resources 210r and/or logical resources 210g. In various embodiments, the abstraction may be implemented in software or logical constructs that manage and represent the resources in a more flexible and interoperable manner. For instance, the abstraction process may be implemented through software mechanisms that create a virtual representation of the resources.

In exemplary embodiments, the physical resources 210r and/or logical resources 210g may be disaggregated into modular units so as to allow for more granular control and management. Information regarding the disaggregation may be used by the access resource abstraction layer as part of abstraction of the physical resources 210r and/or logical resources 210g into universal resource ports 212p. For example, a given access network 210 may include a network of gNBs which can be disaggregated into individual gNBs. Disaggregation may involve identifying each gNB’s name, location (e.g., geographic area, zone, global positioning system (GPS) coordinates, and/or the like), capabilities or supported technologies (e.g., operational frequency range(s), RAT, fiber mode(s), speed, bandwidth, capacity, protocols, operational status, operational limits, etc.), devices or identifiers of devices that the gNB is directly coupled to, and/or the like. Some or all of this information may be used by the access resource abstraction layer as part of abstracting the gNB resources into corresponding universal resource ports 212p. As another example, the same access network 210 or another access network 210 may include multiple fiber links which can be similarly disaggregated into individual fiber links.

In various embodiments, the abstractions by the access resource abstraction layer may be from Layer 2 (e.g., Ethernet or data link layer) and above in the Open Systems Interconnection (OSI) model. The physical resources 210r and/or logical resources 210g may be abstracted to descriptor object(s) that identify the physical resources 210r and/or

logical resources 210g and the corresponding universal resource ports 212p. In one or more embodiments, the access resource abstraction layer 212 may provide a descriptor object for each physical/logical resource and the corresponding universal resource port 212p.

In one or more embodiments, the AIC 214 may be configured to dynamically select abstracted physical/logical resources of the underlying access network(s) 210 to facilitate composition of access network modules and connectivities for packet/service delivery across the access network(s) that support service handling requests from the SMO system 250. Modularization of physical resources 210r (e.g., including both wireline and wireless network resources) and abstraction thereof into universal resource ports 212p advantageously allows the SMO system 250 to perform higher-layer service orchestration and network management across the underlying access network(s) 210 using any type of network technology (wireline and/or wireless) that meets service requirements, which provides a flexible, unified, and interoperable network architecture.

Although not illustrated in FIG. 2A, the network system 200 may similarly include a transport resource abstraction layer or system and a core resource abstraction layer or system. In exemplary embodiments, the transport resource abstraction layer may, similar to that described above with respect to the access resource abstraction layer, be configured to provide abstractions of the resources/devices/components in the transport network(s) 220 as universal resource ports based on disaggregation of the resources/devices/components. The TIC 224 may, similar to that described above with respect to the AIC 214, be configured to dynamically select abstracted physical resources of the corresponding underlying transport network(s) 220 to support service handling requests from the SMO system 250. In a case where the transport network(s) 220 include a mixture of traditional transport technologies (e.g., fiber-based or wireless-based technologies) and access-based technologies, such as PON or IAB, the modularization and abstraction of such transport resources advantageously supports access and transport convergence. In a case where the transport network(s) 220 include a mixture of traditional transport technologies (e.g., fiber-based or wireless-based technologies) and core-based technologies, such as EPC, 5GC, 6GC, and/or BNG, the modularization and abstraction of such transport resources advantageously support transport and core convergence.

In one or more embodiments, the core resource abstraction layer may, similar to that described above with respect to the access resource abstraction layer, be configured to provide abstractions of the resources/devices/components in the core network(s) 230 as universal resource ports based on disaggregation of the resources/devices/components. The CIC 234 may, similar to that described above with respect to the AIC 214, be configured to dynamically select abstracted physical resources of the corresponding underlying core network(s) 230 to support service handling requests from the SMO system 250.

Although not illustrated in FIG. 2A, the network system 200 may similarly include a home/business resource abstraction layer or system and a device resource abstraction layer or system.

In exemplary embodiments, the home/business resource abstraction layer may, similar to that described above with respect to the access resource abstraction layer, be configured to provide abstractions of the resources/devices/components in the home/business network(s) 270 as universal resource ports based on disaggregation of the resources/devices/components. The HIC 274 may, similar to that described above with respect to the AIC 214, be configured to dynamically select abstracted physical resources of the corresponding underlying transport home/business network(s) 270 to support service handling requests from the SMO system 250.

In one or more embodiments, the device resource abstraction layer may, similar to that described above with respect to the access resource abstraction layer, be configured to provide abstractions of the resources/devices/components in the user device(s) 205 as universal resource ports based on disaggregation of the resources/devices/components. The DIC 284 may, similar to that described above with respect to the AIC 214, be configured to dynamically select abstracted resources of the user device 205 to support service handling requests from the SMO system 250.

A metaverse object (and/or its associated immersive environment) may have attributes that can be mapped to physical world attributes and/or resources. For instance, metaverse object attributes may identify properties of a metaverse object (e.g., that it is a resource, that it is an avatar, that it belongs to a “geo area” or “community,” that it includes certain graphics, that it is data intensive, and so on), which can be mapped to resources or

resource capabilities in the physical world. In one or more embodiments, the above-described information in a given metaverse resource inventory 260i may include attributes of a metaverse object that can be used in a mapping of the metaverse object with the physical world. For instance, a metaverse object’s attributes may include data regarding an identifier or ID of the metaverse object, a classification of the metaverse object, location(s) of the metaverse object within the immersive environment, a state of mobility of the metaverse object in the immersive environment, service-dependent geographic area(s) or location(s) (e.g., MEC devices) where instances of the metaverse object (such as software resources and/or other metaverse object data) are stored and accessible, a community with which the metaverse object is associated, and so on. Metaverse objects and their corresponding attributes can be mapped to the physical world. As some examples, a racecar resource in the metaverse having a certain in-game speed (e.g., 200 meters per second) may be mapped to a corresponding real world speed (e.g., 50 kilometers per second), the racecar resource may be mapped to certain network/cell coverage regions of a wireless network and/or to particular RAN resources, a golfer avatar in the metaverse may be mapped to a golfing community, etc.

In one or more embodiments, the SMO system 250 may include a metaverse service and physical world mapping system 252m that is capable of defining or identifying metaverse object attributes and deriving mapping(s) thereof with the physical world based on predefined and/or learned rules. The rules may dictate analyses/comparisons of the metaverse object attributes and known information regarding physical world resources, such as, for example, the communication protocols associated with the resources, capabilities of the resources, services provided by the resources, operational limits associated with the resources, and/or the like. In some embodiments, mappings between metaverse objects and the physical world may be dynamic and/or service dependent. Combinations of different mappings can also be made between a given metaverse object and the physical world.

In certain embodiments, a metaverse object may be mapped with real world, SLA requirement(s) or the like. For instance, a metaverse object’s mobility state may be mapped with network bandwidth requirements—e.g., graphics resolution requirements may be higher for metaverse objects that are “moving” at high speeds in the metaverse,

and thus network bandwidth may need to be higher to properly accommodate graphics content delivery relating to such fast movements. As another example, a metaverse object may be mapped to a particular minimum network latency, where a 5G RAN and core as well as a 5G slice may be needed to facilitate a metaverse service request associated with that metaverse object.

In one or more embodiments, a metaverse object (and/or its associated centralized or distributed software components) may be mapped to real world geographic locations, such as locations of MEC device(s) in which the metaverse object (and/or its associated centralized or distributed software components) are or may be stored. Where a given immersive environment is associated with multiple metaverse objects (e.g., multiple racecar resources in an immersive racing game) distributed across different geographic regions (e.g., stored/operating in MEC device(s) in different geographic areas, such as in different cities, different countries, etc.), each of the metaverse objects may be mapped to its corresponding MEC device(s) and/or to some or all of the MEC device(s) corresponding to the other metaverse objects. An immersive environment (e.g., game) and/or its corresponding metaverse objects (e.g., game objects, such as racecars, etc.) may thus be mappable to real world locations that provide users with coverage for the immersive environment so long as their respective user devices 205 are located in or near (e.g., within threshold distance(s) from) the coverage area(s).

In some embodiments, the metaverse service and physical world mapping system 252m may identify or define a geo area (or community) that includes or encompasses some or all of the coverage areas provided by the various MEC device(s) that are hosting a given immersive environment and/or its corresponding metaverse objects, and may assign each of the metaverse objects of the immersive environment to that community. For instance, a virtual party held between multiple users across different cities in different countries may be associated with a community that corresponds to the coverage areas provided by the MEC device(s) in those different cities/countries that are hosting the metaverse objects and/or their associated centralized or distributed software components. As part of facilitating the provision of metaverse services, particular MEC device(s) may be selected or arranged to store/host a given metaverse object (and/or its associated centralized or distributed software components) so as to provide an overall “good”

community that offers an optimal or improved immersive user experience. Here, one or more sets or instances of access, transport, and core network resources may be instantiated and combined to form a network resource composition for delivering a metaverse service relating to that metaverse object.

In various embodiments, the metaverse resource inventories 260i and/or associated immersion engines may be updated in real-time (or near real-time) as users operate or engage with relevant metaverse objects, connect to or disconnect from the immersive environment, and so on. The MIC 260m may provide such updates to the metaverse service and physical world mapping system 252m accordingly, which can update/generate metaverse and physical world mappings in real-time (or near real-time).

In exemplary embodiments, the metaverse service and physical world mapping system 252m may monitor the availability, conditions, and/or operations of the access network(s) 210, the transport network(s) 220, the core network(s) 230, the home/business network(s) 270, and/or the user device(s) 205 (e.g., by way of controlling and/or communicating with the AIC 214, the TIC 224, the CIC 234, the HIC 274, and/or the DIC 284), and may provide abstractions of the resources of such network(s)/device(s). In some embodiments, the metaverse service and physical world mapping system 252m may, as part of its abstractions, leverage the above-described, abstracted universal resource ports in the various network(s)/device(s).

In some embodiments, the metaverse service and physical world mapping system 252m may similarly monitor the metaverse 260 to provide abstractions of resources in the metaverse 260. In certain embodiments, the metaverse service and physical world mapping system 252m may, as part of its abstractions, leverage any universal resource ports that may be abstracted for the metaverse 260 in an abstraction layer. Resources in the metaverse 260 that can be abstracted include both logical and physical resources, such as the metaverse resource inventories 260i, metaverse objects, immersive environments, immersion engines, and other devices (e.g., edge devices) that store/operate on metaverse-related data.

In exemplary embodiments, the metaverse service and physical world mapping system 252m may provide the aforementioned abstractions in the form of an abstraction bus, which facilitates determining of available (physical, virtual) resources and/or services

provided by such resources, identifying of appropriate resources that can be utilized to satisfy requirement(s) of requested metaverse services, and chaining or stitching of instances of select resources (e.g., by establishing interconnections over standard interfaces) to deliver the metaverse services.

In this way, the metaverse service and physical world mapping system 252m may, in one dimension (e.g., via communications with the AIC 214, TIC 224, CIC 234, HIC 274, DIC 284), have a detailed overview of (e.g., all of) the real world network resources in the various underlying networks/devices 210, 220, 230, 270, and 205, and may, in another dimension (e.g., via communications with the MIC 260m), have a detailed overview of the metaverse 260, which enables the metaverse service and physical world mapping system 252m to provide detailed information for use with designing and configuring the (e.g., optimal or best) composition of physical and virtual world resources to facilitate metaverse services.

As illustrated in FIG. 2A, the network system 200 may include a non-metaverse 265. The non-metaverse 265 may include or may be associated with various digital environments and applications that do not fall under the category of immersive metaverse experiences. These environments and applications may encompass traditional web services, mobile applications, cloud-based services, and/or other digital platforms that provide user interactions and content delivery without the immersive elements of the metaverse. The non-metaverse 265 may be managed by a non-metaverse intelligent controller (NMIC) 265m, which may be configured to manage the use of resources and services within the digital environments. The NMIC 265m may handle tasks such as load balancing, resource allocation, and/or service quality management to ensure efficient and reliable operation of non-metaverse applications. By coordinating with the SMO system 250, the NMIC 265m can dynamically adjust resources and policies to meet the specific requirements of various non-metaverse services.

As illustrated in FIG. 2A, the SMO system 250, which can be implemented in one or more computing devices or servers, may include rApp(s) 252, a service orchestration and network optimization block 254, and a network data collection, management, and control block 256. In various embodiments, the SMO system 250 may be capable of communicating with the AIC 214, the TIC 224, the CIC 234, the HIC 274, and/or the DIC

284 (e.g., via application programming interface (API) calls or the like) to obtain data regarding (e.g., the availability and the load conditions of) the resources in the various access network(s) 210, transport network(s) 220, core network(s) 230, home/business network(s) 270, and/or user device(s) 205. In one or more embodiments, the SMO system 250 may be capable of polling the AIC 214, the TIC 224, the CIC 234, the HIC 274, and/or the DIC 284 for the necessary data or may be notified of state changes or updates (e.g., based on load condition(s) or resource availability satisfying threshold(s)).

In various embodiments, the rApp(s) 252 may include specialized software modules (or microservices) that are configured to perform service management-related functions, such as, for instance, service integrity detection, self-healing, optimization (e.g., approximate optimization), service orchestration, network data collection and management, security management, QoS management, and/or the like. Service integrity detection may involve monitoring the integrity of services across the network to detect issues that affect service quality, such as network faults, performance degradation, or anomalies in service delivery. Self-healing may involve performing actions to correct detected issues, such as rerouting traffic, reallocating resources, or restarting failed components to restore normal service operation and reduce or minimize downtime. Optimization, or approximate optimization, may involve analyzing data to identify opportunities for load balancing, resource allocation, and traffic management, and making real-time adjustments to improve network efficiency and performance. Service orchestration may involve coordinating the deployment and management of services to ensure proper resource allocation and configuration. Network data collection and management may involve gathering and managing data from network elements to provide information to other rApps 252 for informed decision-making and effective network management. Security management may involve monitoring for threats, enforcing policies, and mitigating risks to ensure network and service security. QoS management may involve monitoring performance, enforcing QoS policies, and making adjustments to maintain consistent and reliable service quality for users. In certain embodiments, one or more of the rApps 252 may communicate with various components of the network to gather data, make intelligent decisions, and/or execute actions to maintain or improve service quality. In one or more embodiments, one or more of the rApps 252 may interact with the

service orchestration and network optimization block 254 and the network data collection, management, and control block 256 to ensure efficient and reliable service delivery.

In one or more embodiments, the service orchestration and network optimization block 254 may be configured to provide association/mapping between service requirements and physical network resources, and may interact with the network data collection, management, and control block 256, the AIC 214, the TIC 224, the CIC 234, the HIC 274, the DIC 284, and/or the rApp(s) 252 to facilitate service instantiation and service/network resource chaining to meet the needs of requested services. In various embodiments, the service orchestration and network optimization block 254 may be configured to communicate with the rApps 252 to implement routing policies and make real-time adjustments based on network conditions and service demands. In one or more embodiments, the network data collection, management, and control block 256 may be configured to gather and manage data from network elements across the access network(s) 210, transport network(s) 220, core network(s) 230, home/business network(s) 270, and the user device(s) 205. This data may include performance metrics, fault information, and/or other relevant parameters that are essential for effective network management. The network data collection, management, and control block 256 may provide the necessary data to the rApps 252 and/or the service orchestration and network optimization block 254 so as to enable these functions to make informed decisions and take appropriate actions to maintain service integrity and improve (or optimize or approximately optimize) network performance.

Although not illustrated, the SMO system 250 may include AI/ML functionality that is configured to analyze (e.g., real-time or near real-time) network conditions and predict future network states for improving (or optimizing or approximately optimizing) resource allocation and service delivery. The AI/ML system may utilize ML algorithms to identify patterns and anomalies in network traffic so as to enable proactive management and self-healing. For instance, the AI/ML system may be trained to determine or predict optimal (or approximately optimal) routing paths, predict potential network congestion, and recommend resource allocation strategies to ensure efficient service delivery. In one or more embodiments, the AI/ML system may be trained to make recommendations of resources based on key performance indicators (KPIs), such as latency, packet loss, and/or jitter.

The following is a description of an example of the SMO system 250’s handling of a service request from a system that is attempting to deliver video data to a user device 205. This example illustrates a step-by-step process of the SMO system 250’s leveraging of the intelligent controllers to efficiently manage and deliver a video streaming service.

Assume that the SMO system 250 receives a service request from a video server to stream video to the user device 205. The SMO system 250 may communicate with the AIC 214 to allocate physical resources in the access network(s) 210 for the requested service. The AIC 214 may interact with the access resource abstraction layer to identify the available physical resources. For instance, the access resource abstraction layer may provide abstractions of the various physical resources 210r in the form of universal physical resource ports 212p. The AIC 214 may use information associated with these universal physical resource ports 212p, such data regarding resource name, location, capabilities, etc., to dynamically select the physical resources that meet the SMO system 250’s request. In particular, one or more xApps 214x in the AIC 214 may analyze the service requirements to identify the specific needs of the service, such as bandwidth, latency, and quality of service (QoS) requirements. By understanding the service requirements, the xApp(s) 214x can ensure that it has sufficient information to make an informed decision. The xApp(s) 214x may then use the analysis results as well as the information regarding the universal physical resource ports 212p, including their associated data, to select physical resources for the service. The xApp(s) 214x may use one or more algorithms or policies to evaluate factors such as resource capacity, current load, and compatibility with the service requirements. By integrating both wireline and wireless resources, the xApp(s) 214x provide a unified view of the available resources and selects the most appropriate ones for the service request. As an example, the xApp(s) 214x may select a universal physical resource port 212p (which might happen to correspond to a gNB) that is associated with and/or that is determined to have the capacity to facilitate packet delivery and connectivity for the requested service. As another example, the xApp(s) 214x may additionally, or alternatively, select another universal physical resource port 212p (which might happen to correspond to a GPON) that is associated with and/or that is determined to have the capacity to facilitate the packet delivery. In this way, the AIC 214 may suggest one or more universal physical resource ports 212p to the SMO system 250 for use with handling the service request and/or may derive a routing path involving selected universal physical resource ports 212p for use by the SMO system 250.

The SMO system 250 may additionally, or alternatively, communicate with the TIC 224 to allocate physical resources in the transport network(s) 220 for the requested service. The TIC 224 may interact with the transport resource abstraction layer to identify the available physical resources. For instance, the transport resource abstraction layer may provide abstractions of the various physical resources in the form of universal physical resource ports. The TIC 224 may use information associated with these universal physical resource ports, such as data regarding resource name, location, capabilities, etc., to dynamically select the physical resources that meet the SMO system 250’s request. In particular, one or more xApps 224x in the TIC 224 may analyze the service requirements to identify the specific needs of the service, such as bandwidth, latency, and QoS requirements. By understanding the service requirements, the xApp(s) 224x can ensure that it has sufficient information to make an informed decision. The xApp(s) 224x may then use the analysis results as well as the information regarding the universal physical resource ports, including their associated data, to select physical resources for the service. The xApp(s) 224x may use one or more algorithms or policies evaluate factors such as resource capacity, current load, and compatibility with the service requirements. By integrating various transport technologies, the xApp(s) 224x provide a unified view of the available resources and selects the most appropriate ones for the service request. As an example, the xApp(s) 224x may select a universal physical resource port (which might happen to correspond to an optical fiber link) that is associated with and/or that is determined to have the capacity to facilitate packet delivery for the requested service. As another example, the xApp(s) 224x may additionally, or alternatively, select another universal physical resource port (which might happen to correspond to a PON) that is associated with and/or that is determined to have the capacity to facilitate the packet delivery. In this way, the TIC 224 may suggest one or more universal physical resource ports to the SMO system 250 for use with handling the service request and/or may derive a routing path involving selected universal physical resource ports for use by the SMO system 250.

The SMO system 250 may additionally, or alternatively, communicate with the CIC 234 to allocate physical resources in the core network(s) 230 for the requested service. The CIC 234 may interact with the core resource abstraction layer to identify the available physical resources. For instance, the core resource abstraction layer may provide abstractions of the various physical resources in the form of universal physical resource ports. The CIC 234 may use information associated with these universal physical resource ports, such as data regarding resource name, location, capabilities, etc., to dynamically select the physical resources that meet the SMO system 250’s request. In particular, one or more xApps 234x in the CIC 234 may analyze the service requirements and use one or more algorithms or policies to evaluate the specific needs of the service, such as bandwidth, latency, and QoS requirements. By understanding the service requirements, the xApp(s) 234x can ensure that it has sufficient information to make an informed decision. The xApp(s) 234x may then use the analysis results as well as the information regarding the universal physical resource ports, including their associated data, to select physical resources for the service. The xApp(s) 234x may use one or more algorithms or policies to evaluate factors such as resource capacity, current load, and compatibility with the service requirements. By integrating various core network technologies, the xApp(s) 234x provide a unified view of the available resources and selects the most appropriate ones for the service request. As an example, the xApp(s) 234x may select a universal physical resource port (which might happen to correspond to a core router) that is associated with and/or that is determined to have the capacity to facilitate packet delivery for the requested service. As another example, the xApp(s) 234x may additionally, or alternatively, select another universal physical resource port (which might happen to correspond to a data center) that is associated with and/or that is determined to have the capacity to facilitate the packet delivery. In this way, the CIC 234 may suggest one or more universal physical resource ports to the SMO system 250 for use with handling the service request and/or may derive a routing path involving selected universal physical resource ports for use by the SMO system 250.

The SMO system 250 may additionally, or alternatively, communicate with the HIC 274 to allocate resources in the home/business network(s) 270 for the requested service. The HIC 274 may interact with the home/business resource abstraction layer to identify the available resources. For instance, the home/business resource abstraction layer may provide abstractions of the various physical resources in the form of universal resource ports. The HIC 274 may use information associated with these universal resource ports, such as data regarding resource name, location, capabilities, etc., to dynamically select the resources that meet the SMO system 250’s request. In particular, one or more xApps in the HIC 274 may analyze the service requirements to identify the specific needs of the service, such as bandwidth, latency, and QoS requirements. By understanding the service requirements, the xApp(s) can ensure that it has sufficient information to make an informed decision. The xApp(s) may then use the analysis results as well as the information regarding the universal resource ports, including their associated data, to select resources for the service. The xApp(s) may use one or more algorithms or policies to evaluate factors such as resource capacity, current load, and compatibility with the service requirements. By integrating various home network technologies, the xApp(s) provide a unified view of the available resources and select the most appropriate ones for the service request. As an example, the xApp(s) may select a universal resource port (which might happen to correspond to a Wi-Fi access point) that is associated with and/or that is determined to have the capacity to facilitate packet delivery for the requested service. As another example, the xApp(s) may additionally, or alternatively, select another universal resource port (which might happen to correspond to another Wi-Fi access point) that is associated with and/or that is determined to have the capacity to facilitate the packet delivery. In this way, the HIC 274 may suggest one or more universal resource ports to the SMO system 250 for use with handling the service request and/or may derive a routing path involving selected universal resource ports for use by the SMO system 250. In some embodiments, the HIC 274 may instruct the DIC 284 to control the connection manager 205m to establish a connection with the chosen network resource (e.g., a Wi-Fi access point #1 instead of a Wi-Fi access point #2).

The SMO system 250 may additionally, or alternatively, communicate with the DIC 284 to allocate resources in a given user device 205 for the requested service. The

DIC 284 may interact with the device resource abstraction layer to identify the available resources. For instance, the device resource abstraction layer may provide abstractions of the various physical resources in the form of universal resource ports. The DIC 284 may use information associated with these universal resource ports, such as data regarding resource name, capabilities, etc., to dynamically select the resources that meet the SMO system 250’s request. In particular, one or more xApps in the DIC 284 may analyze the service requirements to identify the specific needs of the service, such as bandwidth, latency, and QoS requirements. By understanding the service requirements, the xApp(s) can ensure that it has sufficient information to make an informed decision. The xApp(s) may then use the analysis results as well as the information regarding the universal resource ports, including their associated data, to select resources for the service. The xApp(s) may use one or more algorithms or policies to evaluate factors such as resource capacity, current load, and compatibility with the service requirements. By integrating various device technologies, the xApp(s) provide a unified view of the available resources and select the most appropriate ones for the service request. As an example, the xApp(s) may select a universal resource port (which might happen to correspond to a CPU) that is associated with and/or that is determined to have the capacity to facilitate packet processing for the requested service. As another example, the xApp(s) 284x may additionally, or alternatively, select another universal resource port (which might happen to correspond to a GPU) that is associated with and/or that is determined to have the capacity to facilitate the packet processing. In this way, the DIC 284 may suggest one or more universal resource ports to the SMO system 250 for use with handling the service request and/or may derive a routing path involving selected universal resource ports for use by the SMO system 250.

Based on communications with the AIC 214, the TIC 224, the CIC 234, the HIC 274, and/or the DIC 284, the SMO system 250 may dynamically select and chain resources across the various networks/devices to provide the service. In various embodiments, the SMO system 250 may continuously monitor the service delivery, using the network data collection, management, and control block 256 to gather real-time information about resource availability and performance. This allows the SMO system 250 to make dynamic adjustments as needed, by communicating with the AIC 214, the TIC

224, the CIC 234, the HIC 274, and/or the DIC 284 for updates on suggested universal physical resource ports, so as to facilitate seamless and high-quality video streaming to the user device 205. By leveraging the abstraction layers and intelligent controllers, the SMO system 250 thus provides a flexible, unified, and interoperable network architecture that is capable of efficiently handling complex service requests.

In exemplary embodiments, the SMO system 250 may be configured to create, by way of the SO system 252c, a resource slice across the access network(s) 210, the transport network(s) 220, the core network(s) 230, the home/business network(s) 270, and a user device 205. The SO system 252c may orchestrate an encompassing slice that spans these various network and device domains. The SMO system 250 may assign a single slice ID to this encompassing slice, and may communicate this slice ID to each of the AIC 214, the TIC 224, the CIC 234, the HIC 274, and the DIC 284. Use of a single slice ID can ensure that all segments of the network and device resources are coordinated under the same slice, which can facilitate seamless E2E service delivery. The SO system 252c may define slice requirements based on an SLA for the requested service. These requirements may include specific parameters such as bandwidth, latency, QoS, and/or processing speed metrics. The SO system 252c may communicate some or all of these slice requirements to each of some or all of the intelligent controllers, which may then manage their respective resource portions to meet these requirements. That is, the AIC 214, the TIC 224, the CIC 234, the HIC 274, and the DIC 284 may be responsible for deciding which specific resources to use within their domains to fulfill the slice requirements. For instance, the AIC 214 may select a particular gNB based on current load and capabilities, the TIC 224 may choose a specific transport link, the CIC 234 may select a specific core network router, the HIC 274 may choose a specific Wi-Fi access point, and the DIC 284 may select a specific device resource, such as a CPU or a GPU. The intelligent controllers may not necessarily inform the SO system 252c of the specific resources that they are using beforehand; instead, the intelligent controllers may dynamically allocate resources as needed to meet the slice requirements. By coordinating these efforts, the SO system 252c can ensure that the entire slice meets the SLA requirements across all network and device segments, thereby providing a consistent and high-quality user experience.

It is to be understood and appreciated that, although FIG. 2A might be described above as pertaining to various processes and/or actions that are performed in a particular order, some of these processes and/or actions may occur in different orders and/or concurrently with other processes and/or actions from what is depicted and described above. Moreover, not all of these processes and/or actions may be required to implement the systems and/or methods described herein. Furthermore, while various systems, devices, components, modules, applications, layers, networks, etc. may have been illustrated in FIG. 2A as separate systems, devices, components, modules, applications, layers, networks, etc., it will be appreciated that multiple systems, devices, components, modules, applications, layers, networks, etc. can be implemented as a single system, device, component, module, application, layer, network, etc., or a single system, device, component, module, application, layer, network, etc. can be implemented as multiple systems, devices, components, modules, applications, layers, networks, etc. Additionally, functions described as being performed by one system, device, component, module, application, layer, network, etc. may be performed by multiple systems, devices, components, modules, applications, layers, networks, etc., or functions described as being performed by multiple systems, devices, components, modules, applications, layers, networks, etc. may be performed by a single system, device, component, module, application, layer, network, etc.

FIG. 2B depicts an illustrative embodiment of a method 290 in accordance with various aspects described herein.

At 290a, the method can include receiving a service request relating to a user device. For example, the SMO system 250 can, similar to that described above with respect to the system 200 of FIG. 2A, perform one or more operations that include receiving a service request relating to a user device.

At 290b, the method can include identifying service delivery requirements for the service request, resulting in identified requirements. For example, the SMO system 250 can, similar to that described above with respect to the system 200 of FIG. 2A, perform one or more operations that include identifying service delivery requirements for the service request, resulting in identified requirements.

At 290c, the method can include obtaining first information from a first intelligent controller regarding resources in one or more networks that are associated with a premises, wherein the premises comprises a residential premises or a commercial premises. For example, the SMO system 250 can, similar to that described above with respect to the system 200 of FIG. 2A, perform one or more operations that include obtaining first information from a first intelligent controller regarding resources in one or more networks that are associated with a premises, wherein the premises comprises a residential premises or a commercial premises.

At 290d, the method can include obtaining second information from a second intelligent controller regarding resources in the user device. For example, the SMO system 250 can, similar to that described above with respect to the system 200 of FIG. 2A, perform one or more operations that include obtaining second information from a second intelligent controller regarding resources in the user device.

At 290e, the method can include based on the identified requirements, the first information, and the second information, selecting a first resource in the one or more networks and a second resource in the user device. For example, the SMO system 250 can, similar to that described above with respect to the system 200 of FIG. 2A, perform one or more operations that include based on the identified requirements, the first information, and the second information, selecting a first resource in the one or more networks and a second resource in the user device.

At 290f, the method can include facilitating service delivery for the user device by coordinating with the first intelligent controller to utilize the first resource for delivery of traffic associated with the service request and by coordinating with the second intelligent controller to utilize the second resource for processing relating to the traffic. For example, the SMO system 250 can, similar to that described above with respect to the system 200 of FIG. 2A, perform one or more operations that include facilitating service delivery for the user device by coordinating with the first intelligent controller to utilize the first resource for delivery of traffic associated with the service request and by coordinating with the second intelligent controller to utilize the second resource for processing relating to the traffic.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2C depicts an illustrative embodiment of a method 292 in accordance with various aspects described herein.

At 292a, the method can include receiving a service request relating to a user device. For example, the SMO system 250 can, similar to that described above with respect to the system 200 of FIG. 2A, perform one or more operations that include receiving a service request relating to a user device.

At 292b, the method can include identifying service delivery requirements for the service request, resulting in identified requirements. For example, the SMO system 250 can, similar to that described above with respect to the system 200 of FIG. 2A, perform one or more operations that include identifying service delivery requirements for the service request, resulting in identified requirements.

At 292c, the method can include obtaining a resource slice based on the service delivery requirements. For example, the SMO system 250 can, similar to that described above with respect to the system 200 of FIG. 2A, perform one or more operations that include obtaining a resource slice based on the service delivery requirements. In some embodiments, obtaining the resource slice may involve creating a new slice or reusing (or selecting) an existing slice or using (or selecting) a preconfigured slice. Reusing an existing slice may involve identifying a previously established slice that meets the current service delivery requirements. This leverages already allocated resources, which reduces a need for additional configuration and setup. The SMO system 250 may, for instance, evaluate the characteristics of existing slices, such as bandwidth, latency, and/or QoS metrics, to determine if they align with the new service requirements. If a suitable slice is found, it can be reused, allowing for rapid deployment and minimizing resource allocation overhead. Alternatively, using a preconfigured slice may involve selecting a slice that has been set up in advance with specific parameters that are tailored to common service scenarios. These preconfigured slices may be designed to meet typical service requirements and can be quickly activated when needed. The SMO system 250 may maintain a library of such slices, each configured with different resource allocations and performance characteristics. By selecting a preconfigured slice, the system can expedite the service delivery process, ensuring that resources are allocated efficiently and effectively to meet the service demands.

At 292d, the method can include providing data regarding the resource slice to a first intelligent controller and a second intelligent controller, wherein the first intelligent controller relates to one or more networks that are associated with a premises, wherein the premises comprises a residential premises or a commercial premises, wherein the second intelligent controller relates to the user device, and wherein the providing causes the first intelligent controller to manage use of resources in the one or more networks to facilitate traffic delivery for the service request and causes the second intelligent controller to manage use of resources in the user device to facilitate data processing for the service request. For example, the SMO system 250 can, similar to that described above with respect to the system 200 of FIG. 2A, perform one or more operations that include providing data regarding the resource slice to a first intelligent controller and a second intelligent controller, wherein the first intelligent controller relates to one or more networks that are associated with a premises, wherein the premises comprises a residential premises or a commercial premises, wherein the second intelligent controller relates to the user device, and wherein the providing causes the first intelligent controller to manage use of resources in the one or more networks to facilitate traffic delivery for the service request and causes the second intelligent controller to manage use of resources in the user device to facilitate data processing for the service request.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

FIG. 2D depicts an illustrative embodiment of a method 294 in accordance with various aspects described herein.

At 294a, the method can include obtaining data regarding one or more local networks, wherein the one or more local networks provide network connectivity for a user device. For example, the HIC 274 can, similar to that described above with respect to the system 200 of FIG. 2A, perform one or more operations that include obtaining data regarding one or more local networks, wherein the one or more local networks provide network connectivity for a user device.

At 294b, the method can include receiving policy information from an SMO system. For example, the HIC 274 can, similar to that described above with respect to the system 200 of FIG. 2A, perform one or more operations that include receiving policy information from an SMO system.

At 294c, the method can include causing the data and the policy information to be provided to an AIC that is associated with one or more access networks, wherein the causing enables the AIC to determine whether to effect a handover for the user device from the one or more local networks to the one or more access networks. For example, the HIC 274 can, similar to that described above with respect to the system 200 of FIG. 2A, perform one or more operations that include causing the data and the policy information to be provided to an AIC that is associated with one or more access networks, wherein the causing enables the AIC to determine whether to effect a handover for the user device from the one or more local networks to the one or more access networks.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

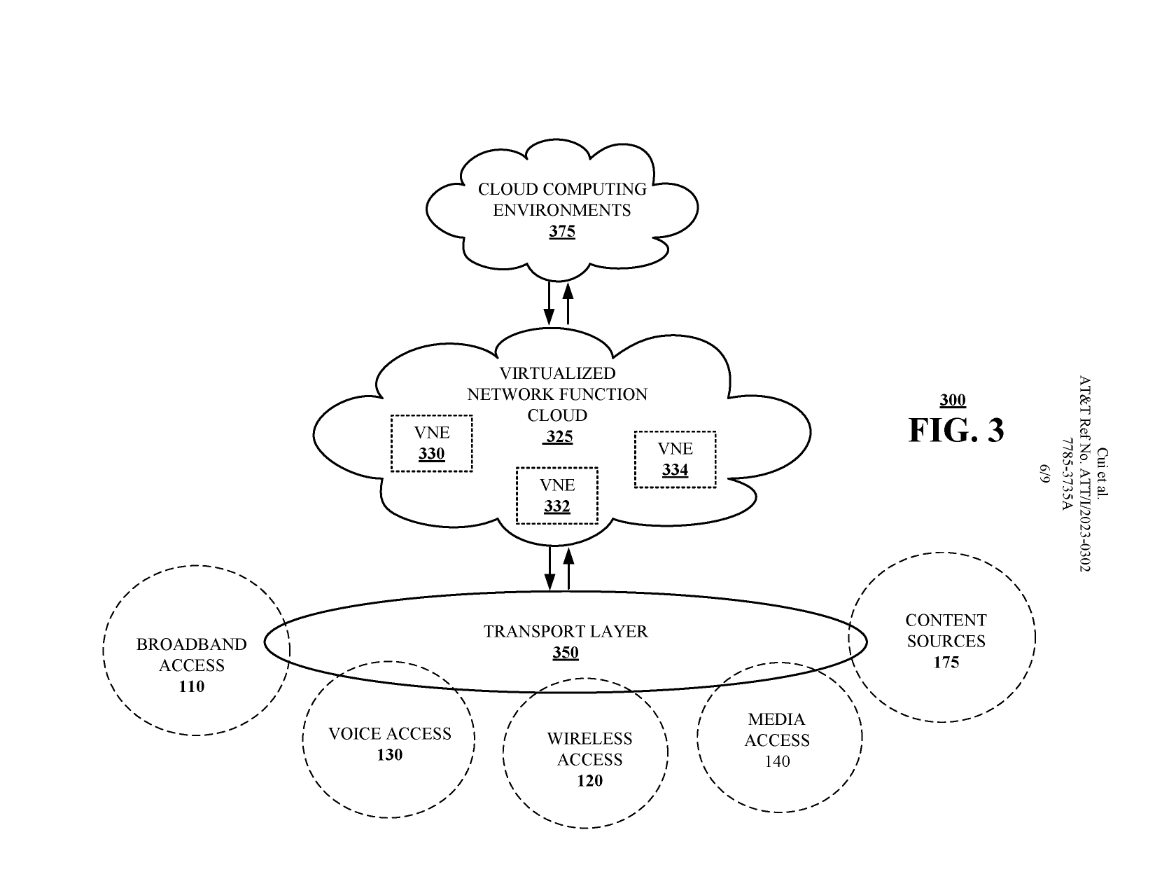

Referring now to FIG. 3, a block diagram 300 is shown illustrating an example, non-limiting embodiment of a virtualized communications network in accordance with various aspects described herein. In particular, a virtualized communications network is presented that can be used to implement some or all of the subsystems and functions of

system 100, the subsystems and functions of system 200, and methods 290, 292, and 294 presented in FIGS. 1, 2 A, 2B, 2C, and 2D. For example, virtualized communications network 300 can facilitate, in whole or in part, E2E dynamic network/resource slicing and selection.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements – which are typically integrated to perform a single function, the virtualized communications network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward substantial amounts of traffic, their workload can be distributed across a number of servers – each of which adds a portion of the capability, and which creates an overall elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

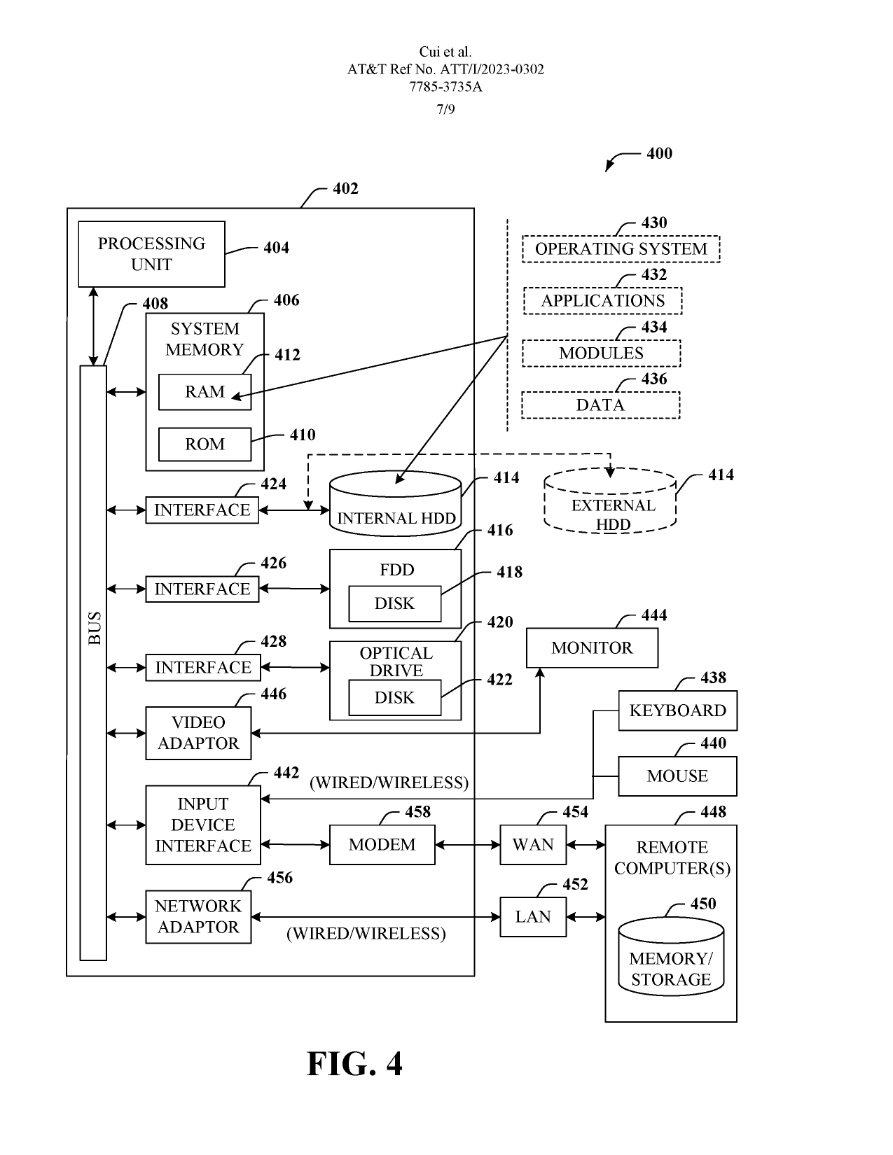

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate, in whole or in part, E2E dynamic network/resource slicing and selection.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communications network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

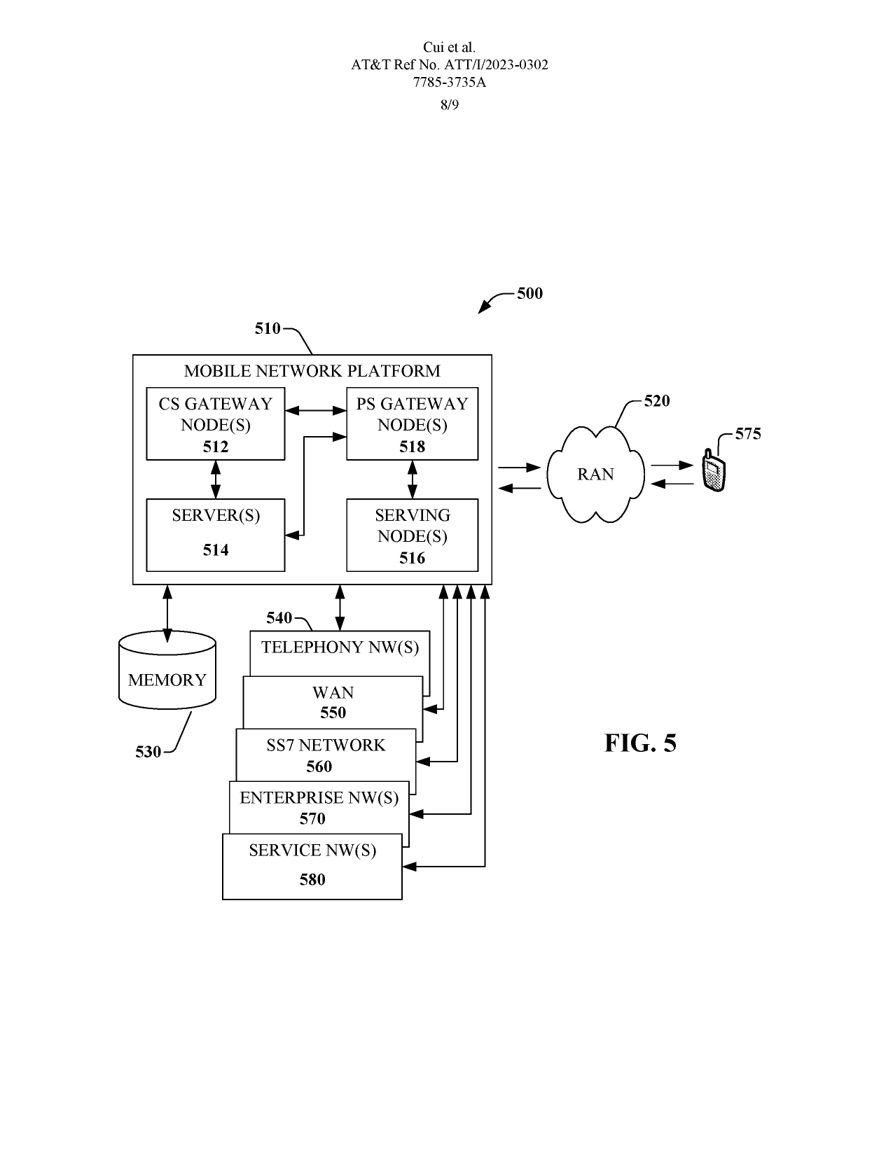

Turning now to FIG. 5, an embodiment 500 of a mobile network platform 510 is shown that is an example of network elements 150, 152, 154, 156, and/or VNEs 330, 332, 334, etc. For example, platform 510 can facilitate, in whole or in part, E2E dynamic network/resource slicing and selection. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, which facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s)

512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format …) such flows. Such application(s) can comprise add-on features to standard services (for example, provisioning, billing, customer support …) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network’s operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as distributed antenna networks that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

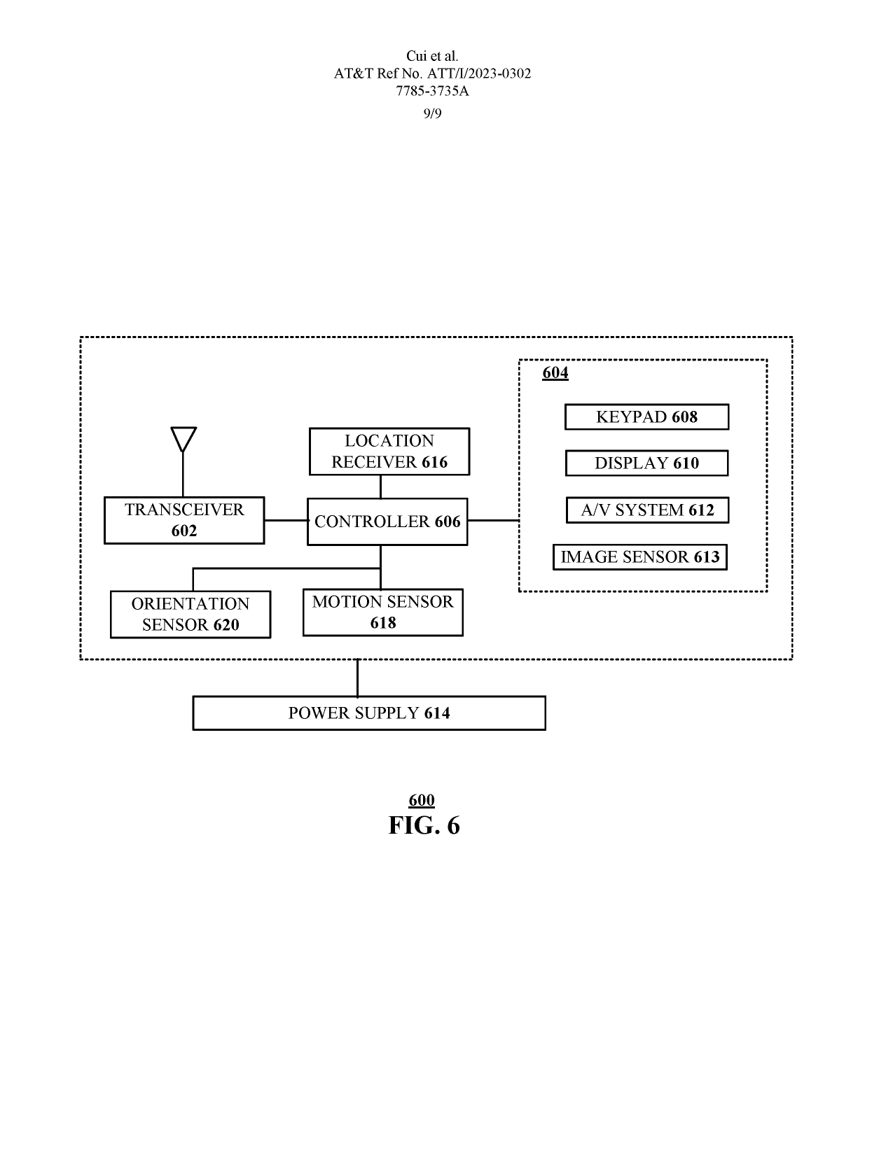

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via communications network 125. For example, computing device 600 can facilitate, in whole or in part, E2E dynamic network/resource slicing and selection.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-

range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth^{®}. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user’s finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth^{®}, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other

storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

In various embodiments, threshold(s) may be utilized as part of determining/identifying one or more actions to be taken or engaged. The threshold(s) may be adaptive based on an occurrence of one or more events or satisfaction of one or more conditions (or, analogously, in an absence of an occurrence of one or more events or in an absence of satisfaction of one or more conditions).

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM),

enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communications network) can employ various AI-based schemes for conducting various embodiments thereof. Moreover, the classifier can be employed to determine a ranking or priority of each cell site of the acquired network. A classifier is a function that maps an input attribute vector,

x = (x1, x2, x3, x4, …, xn), to a confidence that the input belongs to a class, that is, f(x) = confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communications network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to,” “coupled to,” and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized. It is also to be understood and appreciated that the subject matter in one or more dependent claims may be combined with that in one or more other dependent claims.

What is claimed is:

1. A device, comprising:
a processing system including a processor; and
a memory that stores executable instructions that, when executed by the processing system, facilitate performance of operations, the operations comprising:
receiving a service request relating to a user device;
identifying service delivery requirements for the service request, resulting in identified requirements;
obtaining first information from a first intelligent controller regarding resources in one or more networks that are associated with a premises, wherein the premises comprises a residential premises or a commercial premises;
obtaining second information from a second intelligent controller regarding resources in the user device;
based on the identified requirements, the first information, and the second information, selecting a first resource in the one or more networks and a second resource in the user device; and
facilitating service delivery for the user device by coordinating with the first intelligent controller to utilize the first resource for delivery of traffic associated with the service request and by coordinating with the second intelligent controller to utilize the second resource for processing relating to the traffic.

2. The device of claim 1, wherein the receiving comprises receiving the service request from a third-party server.

3. The device of claim 1, wherein the first information and the second information comprise data regarding resource conditions, resource availability, resource capabilities, or a combination thereof.

4. The device of claim 1, wherein the selecting involves use of an artificial intelligence (AI) model that is trained to recommend resources for satisfying service delivery requirements.

5. The device of claim 1, wherein the first intelligent controller comprises a gateway, a router, or another network device that is located at the premises.

6. The device of claim 1, wherein the second intelligent controller is implemented in the user device.

7. The device of claim 1, wherein the resources in the one or more networks comprise wireless local area network (WLAN)-related resources.

8. The device of claim 1, wherein the resources in the user device comprise hardware-related resources.

9. The device of claim 1, wherein the operations further comprise:
obtaining third information from an access intelligent controller (AIC) regarding resources in one or more access networks; and
based on the third information, selecting a third resource in the one or more access networks, wherein the facilitating comprises facilitating the service delivery by further coordinating with the AIC to utilize the third resource for delivery of the traffic.

10. The device of claim 1, wherein the operations further comprise:
obtaining third information from a transport intelligent controller (TIC) regarding resources in one or more transport networks; and
based on the third information, selecting a third resource in the one or more transport networks, wherein the facilitating comprises facilitating the service delivery by further coordinating with the TIC to utilize the third resource for delivery of the traffic.

11. The device of claim 1, wherein the operations further comprise:
obtaining third information from a core intelligent controller (CIC) regarding resources in one or more core networks; and
based on the third information, selecting a third resource in the one or more core networks, wherein the facilitating comprises facilitating the service delivery by further coordinating with the CIC to utilize the third resource for delivery of the traffic.

12. A non-transitory machine-readable medium, comprising executable instructions that, when executed by a processing system including a processor, facilitate performance of operations, the operations comprising:
providing, to a service management and orchestration (SMO) system, information regarding resources in one or more networks, wherein the one or more networks are associated with a premises, wherein the premises comprises a residential premises or a commercial premises, and wherein the providing is responsive to the SMO system receiving a service request relating to a user device;
based on the providing, receiving, from the SMO system, an instruction to utilize a first resource in the one or more networks for delivery of traffic associated with the service request; and
responsive to the receiving, causing the first resource in the one or more networks to be utilized for delivering the traffic.

13. The non-transitory machine-readable medium of claim 12, wherein the information comprises data regarding resource conditions, resource availability, resource capabilities, or a combination thereof.

14. The non-transitory machine-readable medium of claim 12, wherein the processing system comprises an intelligent controller that is implemented in a gateway, a router, or another network device that is located at the premises.

15. The non-transitory machine-readable medium of claim 12, wherein the resources in the one or more networks comprise wireless local area network (WLAN)-related resources.

16. The non-transitory machine-readable medium of claim 12, wherein the traffic is also processed by a second resource in the user device based on information regarding resources in the user device that is provided by a device intelligent controller (DIC) in the user device to the SMO system.

17. The non-transitory machine-readable medium of claim 16, wherein the resources in the user device comprise hardware-related resources.

18. A method, comprising:
providing, by a processing system of a user device including a processor, and to a service management and orchestration (SMO) system, information regarding resources in the user device, wherein the providing is responsive to the SMO system receiving a service request relating to the user device;
based on the providing, receiving, by the processing system and from the SMO system, an instruction to utilize a first resource in the user device for processing relating to traffic that is associated with the service request; and
responsive to the receiving, causing, by the processing system, the first resource in the user device to be utilized for the processing relating to the traffic.

19. The method of claim 18, wherein the traffic is also facilitated by a second resource in one or more networks based on information regarding resources in the one or more networks that is provided by an intelligent controller to the SMO system, and wherein the intelligent controller is implemented in a gateway, a router, or another network device that is located at a residential or commercial premises.

20. The method of claim 19, wherein the resources in the one or more networks comprise wireless local area network (WLAN)-related resources.
